(19) United States
(12) Patent Application Publication
(10) Pub. No.: US 2026/0008652 A1
(43) Pub. Date: Jan. 8, 2026

(54) ELEVATOR SYSTEMS AND PARTS THEREOF

(71) Applicant: Stiltz Limited, Kingswinford (GB)

(72) Inventors: Greg Welch; Tom Miles; Andrew Downing; Andrew Morrice; Peter Gillett; Brett Ackrill

(21) Appl. No.: 18/881,101

(22) PCT Filed: Jul. 3, 2023
(86) PCT No.: PCT/GB2023/051746

§ 371 Date: Jan. 3, 2025

(30) Foreign Application Priority Data
Jul. 4, 2022 (GB) 2209801.6

(51) Int. Cl. B66B 9/02; B66B 11/00; B66B 11/04

(52) U.S. Cl. CPC B66B 9/022; B66B 11/005; B66B 11/0461

(57) ABSTRACT

An elevator drive cassette configured for use in driving the movement of an elevator car along a rail or rack, the elevator drive cassette including: a driven pinion and drive shaft configured to be driven by a drive motor associated with the elevator car; a mechanical coupling; at least one further pinion configured to be driven by the driven pinion or drive shaft via the mechanical coupling, wherein both the driven pinion and at least one further pinion are configured to engage the same rail or rack.

### FIELD

Embodiments relate to elevator systems, elevator drive mechanisms, elevator drive cassettes, elevator fire seal systems, brushes, and the like, which may be for use with or in elevator systems in which an elevator drive mechanism is carried by the elevator car.

### BACKGROUND

Elevator systems include elevators with relatively high weight capacities for use in office buildings, retail environments, and apartment buildings. These are typically relatively expensive and include an elevator shaft or hoistway through which the elevator car travels (often between a large number of different levels). Such elevator systems are typically cable operated and include a machine room at the top of the elevator shaft which includes the hoist machinery which drives movement of the elevator car through the elevator shaft.

However, there is also a growing market for elevator systems which have a lower weight capacity and require less infrastructure for their installation. Such elevator systems are typically associated with domestic environments in which, for example, an elevator system is retrofitted to a domestic property. Elevator systems of this type may be installed to assist elderly or disabled people access the different levels of their residence. There are, however, other environments in which such lower capacity elevators can be used—such as in some commercial environments. Some such elevator systems do not include a hoistway and some do not include a machine room. Indeed, in some examples, the hoist machinery may be carried by the elevator car itself.

Compared to their larger counterparts, such lower weight capacity elevator systems have additional operational requirements. For example, a hoistway-less elevator system must include additional safety systems to avoid damage to property and injury as a result of obstruction of the pathway of an elevator car of such a system (the physical barrier provided by a conventional hoistway not being present). In addition, such systems will often pass through fire-rated ceilings and/or floors (i.e. ceilings and/or floors designed to resist the spreading of fire) and the elevator systems will often need safety systems which maintain the ability of the ceiling and/or floor to act as a barrier against the spreading of fire.

There is also an increasing need for lower weight capacity elevator systems to serve more levels (i.e. more than just two levels).

Moreover, there is a need to keep such elevator systems as quiet and unobtrusive as possible. This can prove particularly difficult because some such systems carry the hoist machinery on the elevator car. As such, the hoist machinery operates in the rooms which the elevator serves, which may be domestic living spaces, for example (i.e. the hoist machinery is not hidden in a machine room and there is no hoistway to help to isolate the sounds of operation of the elevator system from the rooms which the elevator system serves). An associated problem is vibration of the elevator car and other components of the elevator system. Whilst such vibration typically causes noise, vibration can also negatively impact the users of the system—e.g. creating discomfort or nausea, and/or reducing confidence in the safe operation of the system.

In addition, whilst lower weight capacity elevator systems will typically receive routine maintenance, users may be less willing to accept too frequent maintenance than is the case for larger capacity elevator systems (in which the maintenance does not normally require access to domestic rooms due to the provision of a hoistway and machine room). Whilst safe operation of lower capacity elevator systems may be good and relatively long lasting with minimal maintenance, in some instances, issues such as noise and vibration may arise before the elevator system becomes unsafe. As discussed above, users may be less tolerant of such issues in the environments in which lower capacity elevator systems are often installed. Therefore, even if routine maintenance for a conventional lower weight capacity elevator system is viewed as minimal, ideal routine maintenance to avoid issues such as excessive noise and/or vibration may need to be more frequent. Again, users may dislike too frequent maintenance and, therefore, there is a need to maintain the safe, quiet, and vibration-free for as long as possible between routine maintenance.

Some important developments in hoistway-less elevator systems are described in WO2020089606, the contents of which are incorporated herein in their entirety.

Embodiments of the present invention seek to alleviate one or more problems associated with the prior art.

### BRIEF DESCRIPTION OF THE INVENTION

An aspect provides an elevator drive cassette configured for use in driving the movement of an elevator car along a rail or rack, the elevator drive cassette including: a driven pinion and drive shaft configured to be driven by a drive motor associated with the elevator car; a mechanical coupling; and at least one further pinion configured to be driven by the driven pinion or drive shaft via the mechanical coupling, wherein both the driven pinion and at least one further pinion are configured to engage the same rail or rack.

The mechanical coupling may include: a first transfer gear configured to be driven by the drive shaft; an idler gear configured to be driven by the first transfer gear; and a second transfer gear configured to be driven by the idler gear, the second transfer gear being configured to drive the at least one further pinion.

The first transfer gear, the idler gear, the second transfer gear, the driven pinion, and the at least one further pinion, may be provided in a stack, with the first transfer gear, the idler gear, the second transfer gear provided in one layer of the stack, and the driven pinion and the at least one further pinion provided in a second layer of the stack.

An elevator drive cassette may further include one or more rollers configured to engage a part of the rail or rack, and/or another part of an elevator system with which the elevator drive cassette is to be used.

The at least one further pinion may include at least two further pinions.

The cassette may be configured to be secured and removed from a frame of an elevator drive mechanism as a unitary piece.

Another aspect provides an elevator drive cassette configured for use in driving the movement of an elevator car along a rail or rack, the elevator drive cassette including: a bearing block; and one or more linear bearings supported by the bearing block and configured to support the passage of the rail or rack therethrough.

The or each linear bearing may include a collar and a plurality of inward extensions defining a tube-like channel through which the rack or rail is passable.

An elevator drive cassette may further include a pinion configured to engage the rail or rack, the pinion being configured to be driven by a drive motor.

An elevator drive cassette may further include a flexible mounting mechanism configured to permit movement between the elevator drive cassette and a frame to which the elevator drive cassette is mountable.

The flexible mounting mechanism may include one or more cushioned mounting blocks and a flexible mounting mechanism bracket, the one or more cushioned mounting blocks being configured to be sandwiched between the frame and the flexible mounting mechanism bracket with the frame above the flexible mounting mechanism bracket.

The flexible mounting mechanism may further include a flexible mounting spring secured between a main body of the elevator drive cassette and the flexible mounting mechanism bracket.

The flexible mounting mechanism may be configured to permit rotational movement between the elevator drive cassette and the frame to which the elevator drive cassette is mountable.

Another aspect provides an elevator system including: an elevator car with a transportation compartment; a rack or rail along which the elevator car is configured to be driven; and an elevator drive mechanism configured to drive the elevator car along the rack or rail, wherein the elevator drive mechanism includes at least one elevator drive motor and at least one elevator drive cassette as above.

Another aspect provides a brush for contacting a conductor for the transfer of electrical power, the brush including: a brush member formed from an electrically conductive material; a first biasing stage configured to bias the brush member in a first direction; and a second biasing stage configured to bias the first biasing stage in the first direction.

Another aspect provides an elevator fire seal system, the system including: a cable spool mountable to an elevator car and configured to collect and release a cable; and a fire seal member mountable to the elevator car and suspended by the cable, such that release of the cable from the cable spool permits movement the fire seal away from the elevator car and collection of the cable by the cable spool moves the fire seal towards the elevator car.

The cable spool may be a spring biased cable spool.

Another aspect provides an elevator system including: an elevator car with a transportation compartment; and an elevator fire seal as above.

The cable spool may be mounted above or below the transportation compartment.

Another aspect provides an elevator system including: an elevator car with a transportation compartment; a rack or rail along which the elevator car is configured to be driven; an elevator drive mechanism configured to drive the elevator car along the rack or rail, wherein the elevator drive mechanism includes at least one elevator drive motor and at least one elevator drive cassette as above; and an elevator fire seal as above.

An elevator system may further include the brush as above.

### BRIEF DESCRIPTION OF THE FIGURES

In order that the present disclosure may be more readily understood, preferable embodiments thereof will now be described, by way of example only, with reference to the accompanying drawings, in which:

FIG. 1 shows part of an elevator system of some embodiments;

FIG. 2 shows a schematic view of an elevator system installed in a building;

FIGS. 3-6 show perspective views of a part of an elevator drive mechanism of one version;

FIG. 7-9 show views of part of an elevator drive cassette of the version of the elevator drive mechanism in FIGS. 3-6 with FIGS. 8 and 9 having components removed;

FIG. 10 shows a perspective view of a channel member of some versions;

FIG. 11 shows a perspective view of an elevator system with an elevator drive mechanism of another version;

FIGS. 12-14 show perspective views of an elevator drive cassette of the elevator drive mechanism of FIG. 11;

FIGS. 15 and 16 show views of the elevator drive cassette from FIGS. 12-14 but with a bearing block removed;

FIG. 17 shows a perspective view of the elevator drive cassette of the FIGS. 12-14;

FIGS. 18 and 19 show views of a linear bearing;

FIG. 20 show a bearing block;

FIGS. 21-24 show a fire seal system (with a side panel removed in FIG. 24);

FIG. 25 shows sensors which may be used in some versions;

FIG. 26 shows parts of the elevator system;

FIG. 27 shows a conductor and channel member according to some versions; a brush and conductor of some versions;

FIG. 28 shows a channel member and a conductor according to some versions;

FIG. 29 shows a brush, a channel member and a conductor according to some versions;

FIG. 30 shows a perspective view of a brush of some versions;

FIG. 31 shows a cross-section through the brush of FIG. 30; and

FIGS. 32 and 33 show perspective views of parts of the brush of FIGS. 30 and 31.

### DETAILED DESCRIPTION OF THE DISCLOSURE

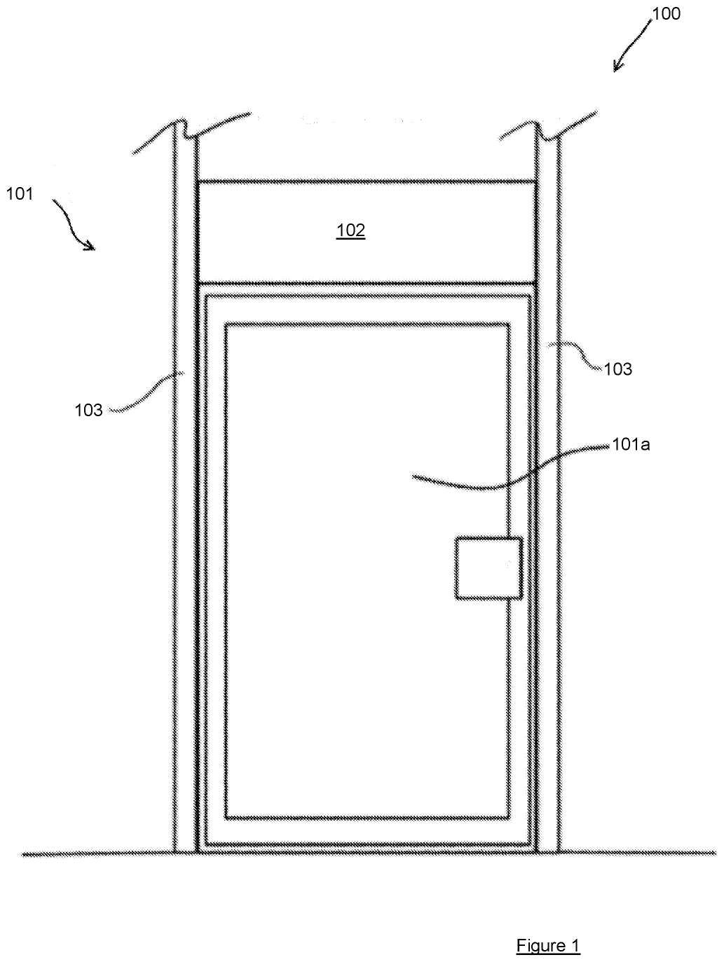

With reference to FIGS. 1, 2 and 11, for example, some versions of the present technology include an elevator system 100 which may be a low capacity elevator system 100 which has a maximum load capacity of less than 350 kg or less than 300 kg or less than 200 kg, for example. The elevator system 100 may be configured for installation in a domestic application and may be configured to be retrofitted to an existing building (which may be a residence, for example). The elevator system 100 may be hoistway-less (in that the elevator system 100 includes no hoistway and needs no hoistway for its operation). The elevator system 100 may be located in domestic rooms, for example.

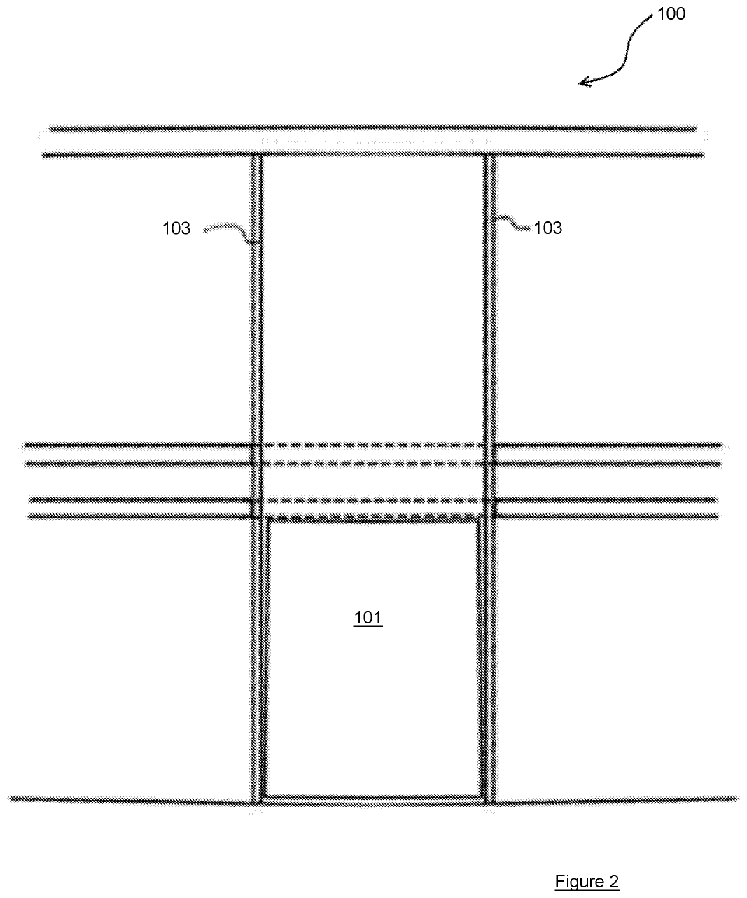

In some versions of the technology, the elevator system 100 includes an elevator car 101 which is configured to move between different levels of the building (as shown in FIG. 2 which shows two levels separated by a ceiling and floor) in relation to which the elevator system 100 is provided. The elevator car 101 may include a transportation compartment 101a which may be configured to carry one or more people or objects, for example. The transportation compartment 101a may be accessed through a door of the elevator car 101 and that door may be carried with the rest of the elevator car 101 as the elevator car 10 moves between levels of the building.

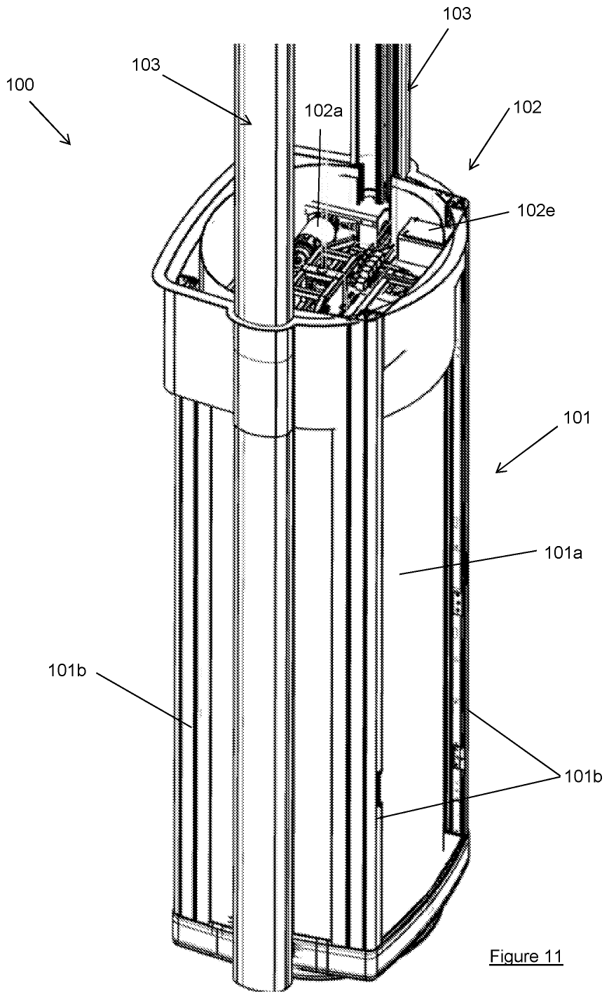

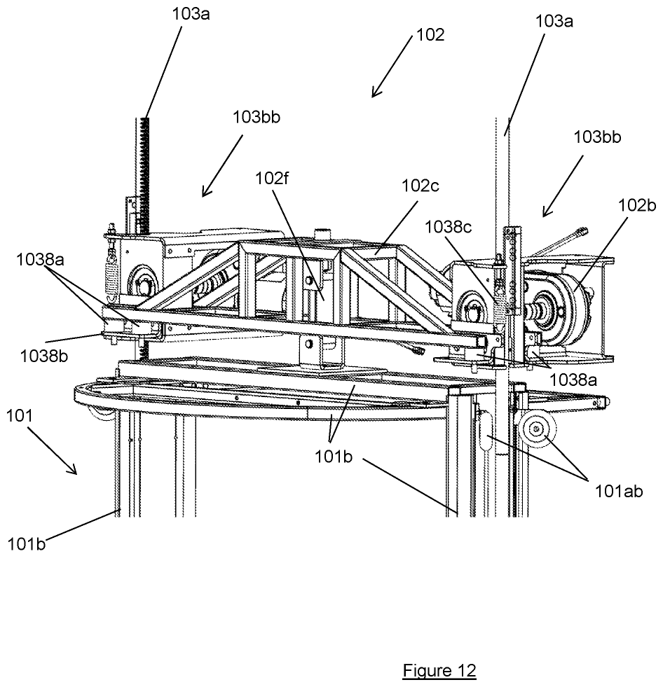

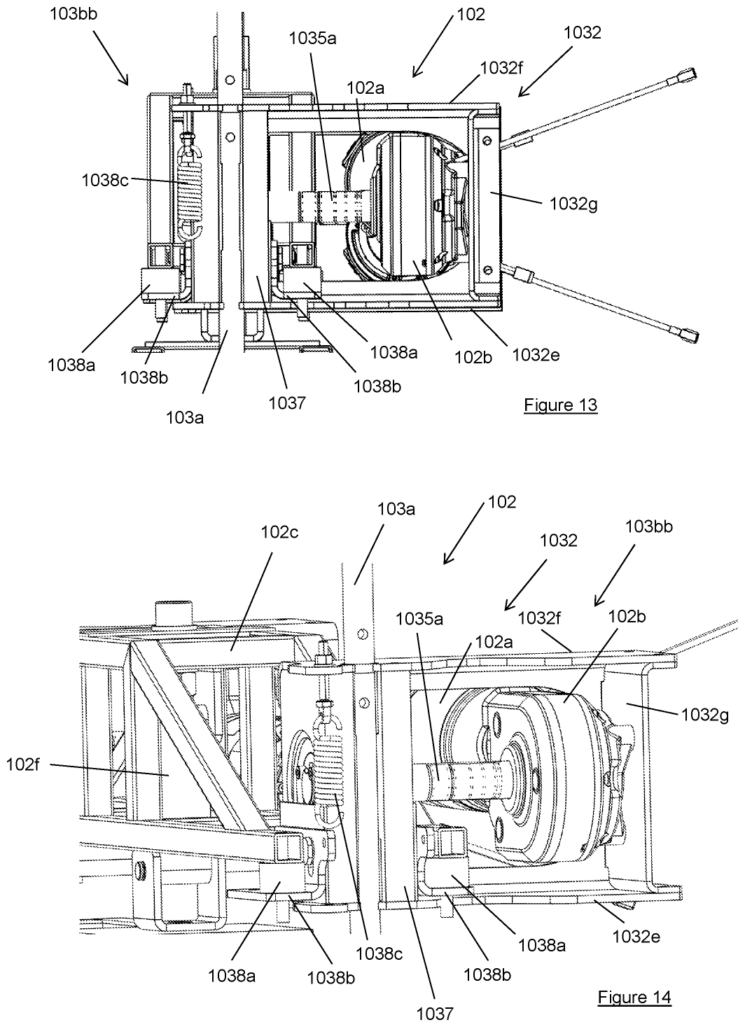

The elevator system 100 may include an elevator drive mechanism 102 which is configured to drive movement of the elevator car 101 between the different levels of the building (see FIGS. 1 and 11 for example). The elevator drive mechanism 102 may be located above or below the transportation compartment 101a. The elevator drive mechanism 102 may be at least partially carried by the elevator car 101 and, in particular, the elevator car 101 may carry an elevator drive motor 102a of the elevator drive mechanism 102 (see FIGS. 1, 3-6, and 11-17, for example). The elevator drive motor 102a may be configured to drive the movement of the elevator car 101 and, so, the operation of the elevator drive mechanism 102.

The elevator drive mechanism 102 could take a number of different forms. In some examples, the elevator drive mechanism 102 may be a cable-drive system, for example (and, incidentally, FIG. 22 is a cable-drive system operated elevator car 101, although the versions of the technology described in relation to that figure may be used with other forms of drive system). The elevator drive mechanism 102 may be, for example, similar to that taught by AU2005200669. However, the majority of versions of the present technology will be described with reference to a rail or rack-and-pinion drive system. It will be appreciated, however, that some aspects of what is described will be equally applicable to other drive systems (such as cable-drive systems) and are not limited to their use in rail or rack-and-pinion drive systems. Cable-drive systems are, however, known—e.g. see AU2005200669—and represent conventional technology. Therefore, no detailed description of such systems is presented herein.

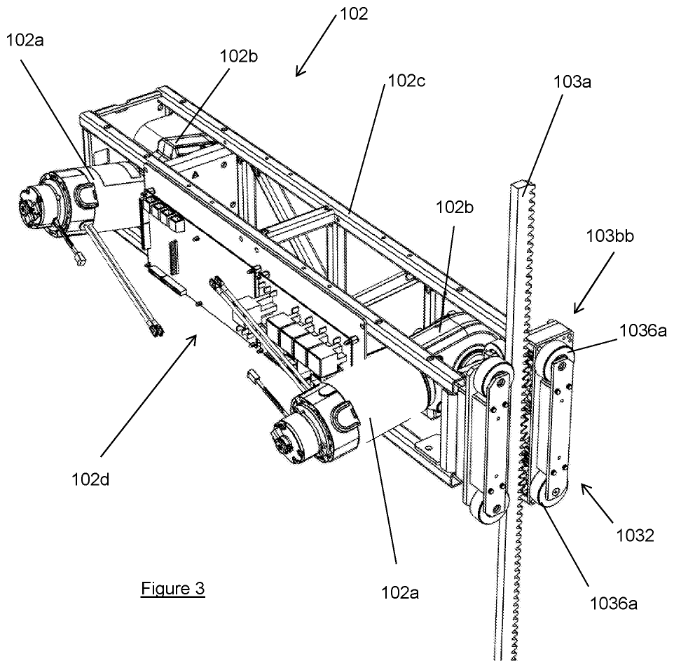

With this in mind, in some versions, the elevator drive mechanism 102 may be a rail drive system. As used herein, a rail drive system is intended to encompass elevator drive mechanisms 102 in which the elevator drive mechanism 102 moves along a rail 103a (e.g. a rigid rail 103a) and the movement is driven by an engagement of the elevator drive mechanism 102 and the rail 103a. An example of a rail drive system is, therefore, a rack-and-pinion drive system. However, instead of a rack 103a, a threaded elongate member may be provided and the pinion may be replaced by a correspondingly threaded member secured to the threaded elongate member for movement along a length thereof by rotation of the threaded elongate member with respect to the correspondingly threaded member (or vice versa). Portions of the rail 103a may be seen in FIGS. 3-9, 12-15, and 17, for example. As used herein, the term rail 103a is intended to encompass a rack 103a.

In some versions, the elevator system 100 may include one or more channel members 103 (which may be fitted to the building which the elevator system 100 serves)—see FIGS. 1, 2, 10 (which shows a section of channel member 103 in isolation), and 11, for example. The one or more channel members 103 may be elongate channel members 103 which extend along the length of travel of the elevator car 101. The or each channel member 103 may be fixedly secured to the building and, for example, one or both ends of the or each channel member 103 may be secured to a floor or ceiling or joist or other part of the structure of the building. This may be achieved, for example, using one or more bolts (e.g. in a nut and bolt arrangement). In some versions, the or each channel member 103 is secured to the building at one or more respective locations along its length between the ends thereof and this may help to reduce vibration and noise.

The or each channel member 103 may have a generally c-shaped cross-section, and may have a generally E-shaped cross-section (e.g. a c-shaped cross-section with a protrusion between the two remote parts thereof)—see FIG. 10 for example. The or each channel member 103 may have a uniform cross-section along substantially all of its length and, in some versions, along the entire length. Accordingly, the protrusion may be an elongate protrusion running a or the length of the channel member 103 of which it is a part.

The rail 103a (which may be the rack 103a) may be located within the confines of a one of the or each channel member 103 and, in some versions, there may be multiple channel members 103 each with a respective rail 103a (e.g. a rack 103a) located therein. Accordingly, the channel member or members 103 may inhibit access to and/or cover at least part of the rail 103a (or rack 103a). In other words, from at least one side, the channel member or members 103 inhibit access to and/or sight of at least part of the rail 103a (or rack 103a)—this may be for safety and/or aesthetics.

The rail 103a (or rack 103a) may extend along a length of the channel member 103 in which it is located and may extend substantially along the entire length of the channel member 103 in which it is located. The same may be true of all rails 103a (or racks 103a) and their respective channel members 103 according to some versions.

The or each channel member 103 may extend generally in a direction of travel of the elevator car 101 of the elevator system 100. In some versions, the or each channel member 103 is a substantially vertical channel member 103.

The rail 103a (or rack 103a) may be mounted to the channel member 103 in which it is located and may extend parallel thereto. The rail 103a (or rack 103a) may be a substantially vertical rail 103a (or rack 103a).

The rail 103a (or rack 103a) may be secured to the channel member 103 in which it is located and/or may be secured in position relatively thereto. The rail 103a (or rack 103a) may be secured by the use of one or more bolts, for example, which pass through a part of the rail 103a (or rack 103a) and at least part (e.g. the protrusion) of the channel member 103 in which it is located. In some versions, the rail 103a (or rack 103a) may be adhered to the channel member 103 or welded thereto, for example. In some versions, the rail 103a (or rack 103a) includes one or more mounting brackets and the rail 103a (or rack 103a) is secured to the channel member 103 via the or each mounting bracket. In some versions, the rail 103a (or rack 103a) is secured to the building via one or both ends thereof and, in some such versions, may not be attached to the channel member 103 in which it is located.

In some versions, the rail 103a (or rack 103a) is provided in sections which have a shorter length than a length of the channel member 103 in which the rail 103a (or rack 103a) is located. Accordingly, it may be necessary to use a rail 103a (or rack 103a) which comprises a number of rail 103a (or rack 103a) sections aligned with each other in a linear manner.

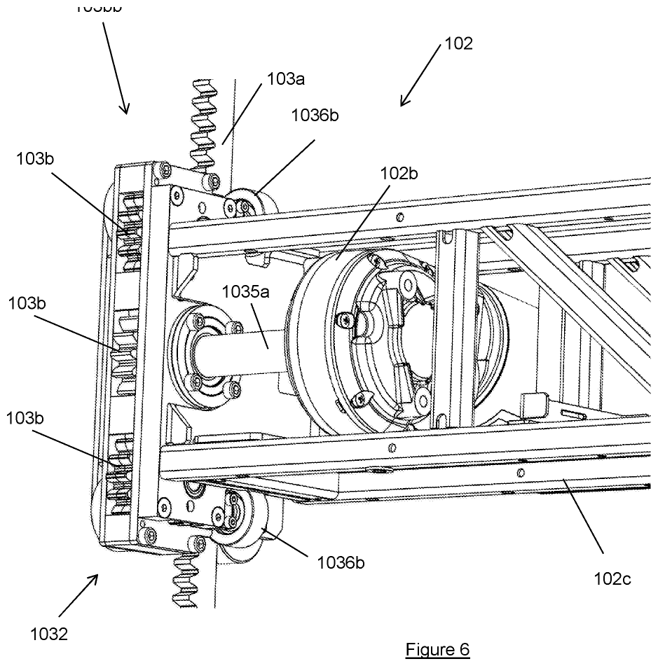

In some versions, the rail 103a (or rack 103a) includes a plurality of teeth 1031a—see FIGS. 7-9 and 15, for example. The teeth 1031a may be arranged to face the same direction along the length of the rail 103a (or rack 103a). This direction may be forwardly or backwardly or sideways inwardly or sideways outwardly, for example. In this sense, forwardly refers to a direction in which access to the transportation compartment 101a is provided, backwardly is a direction towards an opposing side of the transportation compartment 101a, sideways inwardly is a direction towards the elevator car 101 (or towards a first side of the elevator car 101 depending on the position of the rail 103a or rack 103a), and sideways outwardly is in a direction away from the elevator car 101 (or towards a second side of the elevator car 101 depending on the position of the rail 103a or rack 103a).

The channel member 103 may be formed from a metal, such as aluminum. The rail 103a (or rack 103a) may be formed from a metal, such as steel (which may be stainless steel or not). In some versions, the channel member 103 may be formed from a plastics material.

In some versions, the channel member 103 and the rail 103a (or rack 103a) are integrally formed.

In some versions, see FIG. 3-9 for example, the rail 103a or rack 103a is a rack 103a which generally comprises an elongate member with a generally rectangular cross-section and teeth 1031a provided on a shorter surface thereof. The teeth 1031a may be provided generally perpendicular to the direction of extension of the elongate rack 103a. In some versions, the teeth are angled with respect to this perpendicular direction (e.g. inclined or declined).

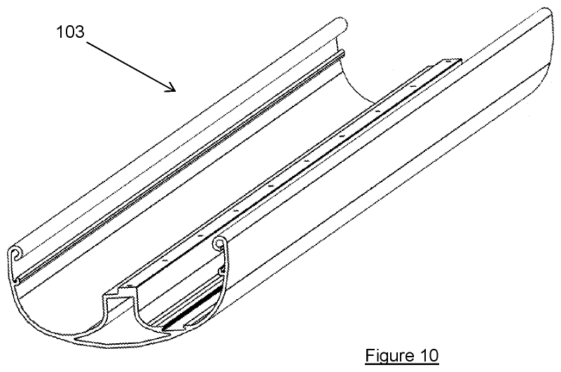

In some versions, see FIG. 12-17 for example, the rail 103a or rack 103a is in the form of a rail 103a. In some such versions the rail 103a may include an elongate member with a generally circular cross-section. Teeth 1031a may be provided facing one direction and those teeth may extend through 180 degrees or less of the circumference of the cross-section of the rail 103a. The teeth 1031a may be provided generally perpendicular to the direction of extension of the elongate rail 103a. In some versions, the teeth are angled with respect to this perpendicular direction (e.g. inclined or declined).

In some versions, the or each channel member 103 extends through the entire length (i.e. height) which the elevator car 101 is to travel. In some embodiments the or each channel member 103 extends through each level which the elevator system 100 is configured to serve (i.e. to which the elevator system 100 is configured to deliver the elevator car 101) from the floor of each level to the ceiling of each level. This need not be the case, however, in relation to the uppermost level which the elevator system 100 is configured to serve-at which the or each channel member 103 may be configured to extend a part of the length/height of that level. The or each channel member 103 may extend also through any horizontal partition between levels (e.g. a ceiling and/or floor). In some versions, due to the position of the elevator drive mechanism 102 (e.g. above the transportation compartment 101a) a full range of movement of the elevator car 102 relative to the channel member(s) 103 (and so the building) may be achieved without the or each rail 103a (or rack 103a) extending through a lowermost portion of its associated channel member 103.

In some versions, there is one single (i.e. one and only one) channel member 103 housing one rack 103a and the elevator car 101 may be cantilevered with respect thereto. In some versions, however, there is more than one channel member 103. In some embodiments, a first channel member 103 may be provided on the first side of the elevator car 101 and a second channel member 103 may be provided on the second side of the elevator car 101 (the first and second sides of the elevator car generally opposing each other). Accordingly, the first and second channel members 103 may be provided across a width of the elevator system 100. In some versions, one or more further channel members 103 may be provided (and the one or more further channel members 103 may or may not include a rail 103a or rack 103a).

In some versions, there is more than one channel member 103 (e.g. two—see FIG. 11) and at least two channel members 103 each include a respective rail 103a (or rack 103a). In some versions, there are three channel members 103 which each may include a respective rail 103a (or rack 103a) and, in some versions, there are four channel members 103 which each include a respective rail 103a (or rack 103a). The channel members 103 may be provided in pairs on opposing sides or parts of the elevator car 101 or elevator system 100. In some versions, other distributions of channel members 103 around the elevator car 101 or elevator system 100 may be provided.

As described herein, the elevator car 101 may be carried between levels of the building using the or each rail 103a (or rack 103a). To this end, the elevator drive mechanism 102 may be configured to drive movement of the elevator car 101 along the or each rail 103a (or rack 103a) and the or each rail 103a (or rack 103a) may be provided in the building extending between the levels which are to be serviced by the elevator system 100.

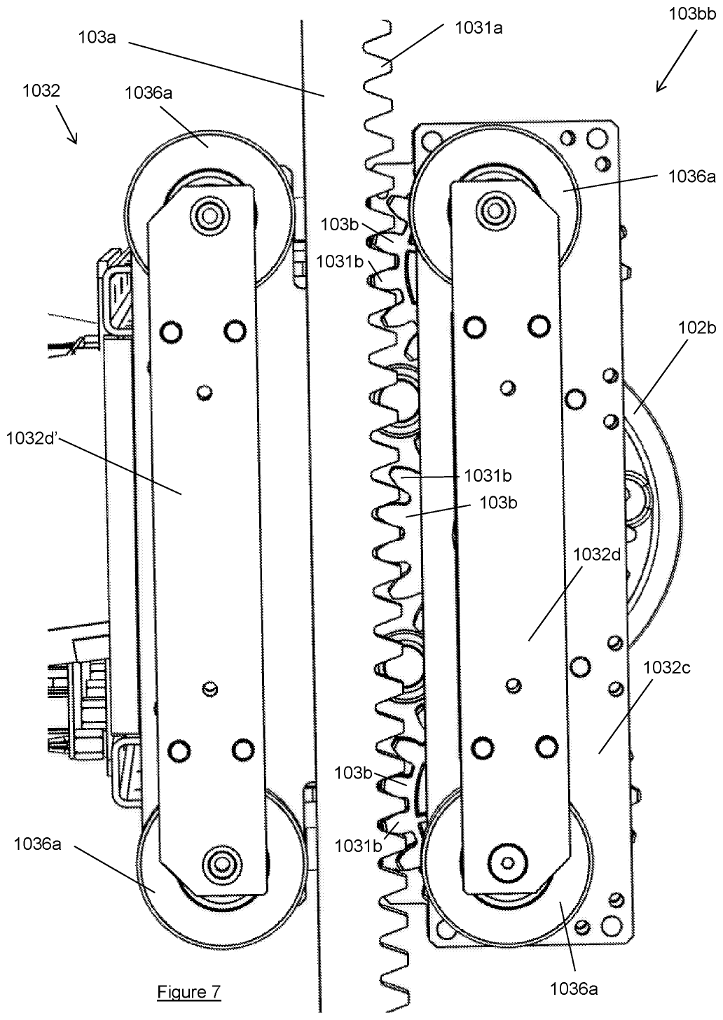

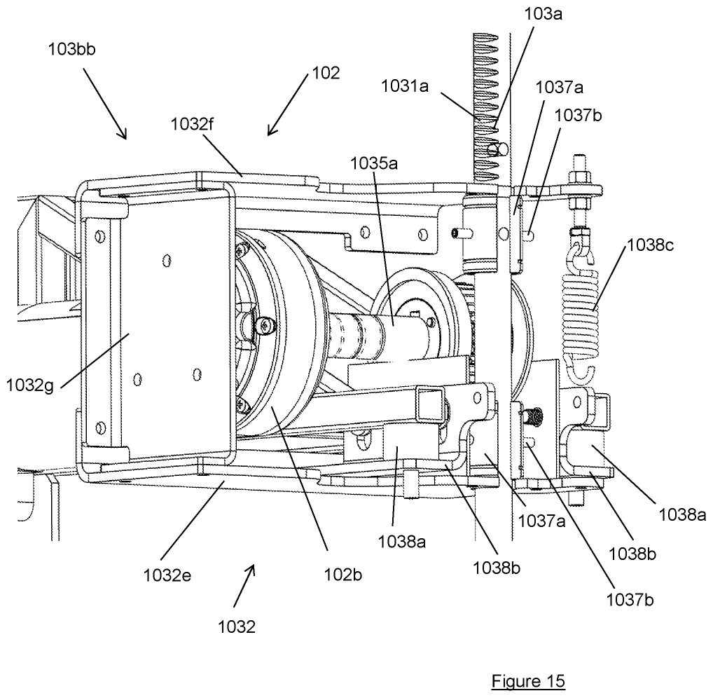

The elevator car 101 may carry one or more drive gears 103b (or pinions 103b)—see FIGS. 8 and 16 for example, each of which is configured to engage one of the or each rails 103a (or racks 103a). The or each drive gear 103b or pinion member 103b may, therefore, have a plurality of teeth 1031b configured to mate with the teeth 1031a of the rail 103a (or rack 103a).

The or each drive gear 103b (or pinion 103b) may be provided as part of the elevator drive mechanism 102 which may, as described herein, be mounted for movement with the elevator car 101 (e.g. above and/or below a transportation compartment 101a of the elevator car 101—the transportation compartment 101a being a compartment for the transportation, by the elevator car 101, of one or more people and/or objects, see FIG. 1 or 11).

In some versions, the or each drive gear 103b (or pinion 103b) is provided as part of the elevator drive mechanism 103 above the transportation compartment 101a. In some such versions, there may be two drive gears 103b (or pinions 103b) which may be provided on generally opposing sides of the elevator car 101 and which are, accordingly, configured to engage respective rails 103a (or racks 103a) provided on generally opposing sides of the elevator car 101 (each rail 103a (or rack 103a) being housed in a channel member 103 and there being, as such, two channel members 103 provided on generally opposing sides of the elevator car 101). These opposing sides may be the first and second sides, for example—see FIG. 11.

In some versions, the or each drive gear 103b (or pinion 103b) is provided as part of a drive cassette 103bb—see FIGS. 3-9 and 12-17 for example. In some versions there are a plurality of drive cassettes 103bb provided. Each drive cassette 103bb may be associated with one rail 103a (or rack 103a) and may be configured for engagement with one rail 103a (or rack 103a). Each drive cassette 103bb may carry a plurality of drive gears 103b (or pinions 103b) and all drive gears 103b (or pinions 103b) of a single drive cassette 103bb may be configured to engage a single rail 103a (or rack 103a)—although that single rail 103a (or rack 103a) may be provided as a plurality of sections arranged in a linear manner as described herein.

The drive cassette 103bb may be removed and/or attached to, for example, a frame 102c of the elevator drive mechanism 102 as a unitary piece (i.e. without requiring the individual parts to be disassembled first).

With reference to FIG. 3-9, versions of the drive cassette 103bb are described with reference to a rack 103b, although it will be appreciated that such versions may be used with other forms of rail 103b (such as with the rail 103b of the type described with reference to FIGS. 11-17).

As described, the drive cassette 103bb may include a plurality of drive gears 103b (or pinions 103b)—see FIGS. 7 and 8 for example. These will be referred to in relation to these versions of the technology as pinions 103b but it will be appreciated that other forms of drive gear 103b may be used.

The drive cassette 103bb includes a main body 1032 which is configured to support, at least in part, the pinions 103b with respect to the rack 103a. The main body 1032 may include a framework and/or one or more plates and/or one or more mounting brackets, as may be required to hold the various parts in their required positions as described herein.

The drive cassette 103bb depicted in FIGS. 3-9 includes three pinions 103b but it will be appreciated that some versions may include two pinions 103b and some versions may include more than three pinions 103b. There may be fewer than six pinions 103b in some versions, as part of a single cassette 103bb. The pinions 103b may be supported by the main body 1032 and may be mounted to the main body 1032 such that they are rotatable with respect thereto. Accordingly, each pinion 103b may be mounted on a pinion shaft and a bearing (such as a ball bearing) may be provided between the main body 1032 and the pinion shaft, with the pinion 103b being configured to rotate with its pinion shaft.

The pinions 103b may be arranged to engage the rack 103a at different respective locations along the length of the rack 103a, at a given movement in time during use—as can be seen in FIGS. 6 and 8 for example. The pinions 103b may be all substantially the same size and shape—see FIG. 8 for example. The pinions 103b may be described, therefore, as a linear array of pinions 103b. The teeth 1031b of the pinions 103 may all be directed towards the same side and this side may be the location, in use, of the teeth 1031a of the rack 103a. The main body 1032 may, therefore, be configured to support the pinions 103b in this arrangement.

The pinions 103b may be configured such that they do not engage each other—see FIG. 8 for example. In other words, the maximum diameter of each pinion 103b (which may be the same diameter for each pinion 103b) is less than a separation between rotational axes of any two adjacent pinions 103b. As will be understood, the rotational axes of the pinions 103b are defined by the pinion shafts and these rotational axes may be generally arranged such that they are parallel with each other and may be such that they are equidistant from the rack 103a in use.

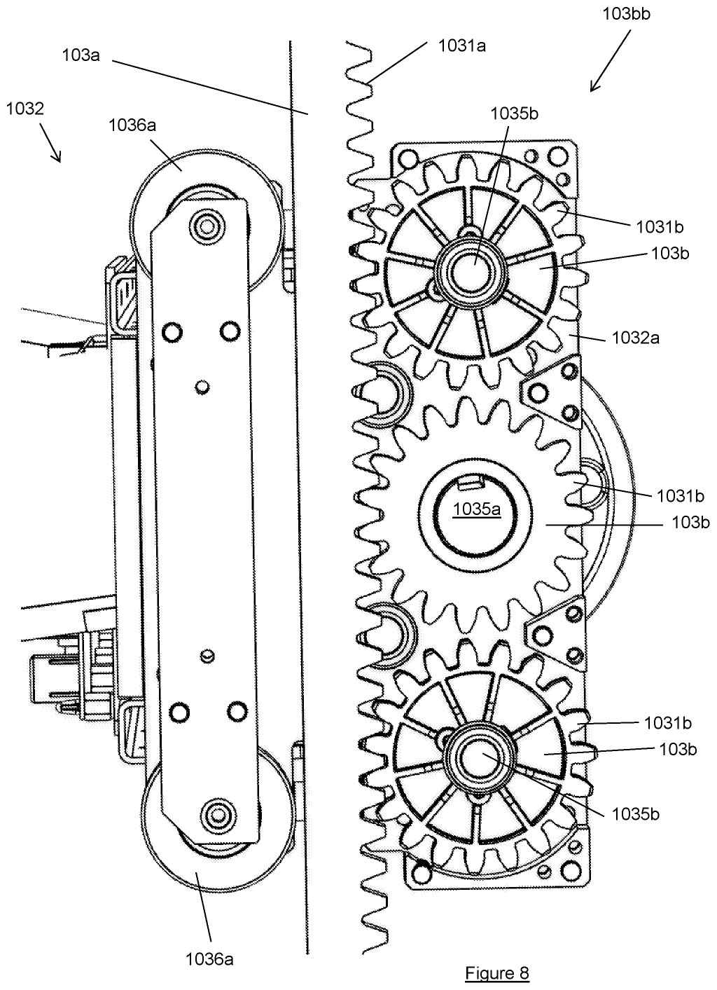

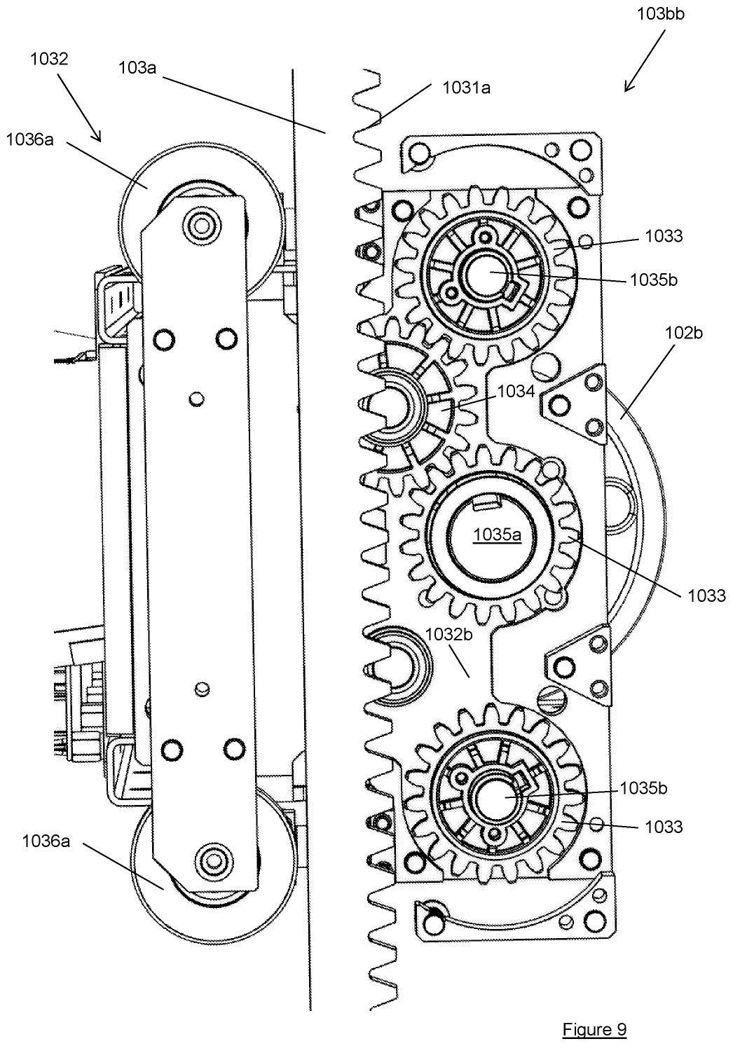

The pinions 103b are located outwardly, relative to the elevator car 101 such that the pinions 103b are adjacent and engage the rack 103a. Inwardly of the pinions 103b (in a location which may be inwardly of the rack 103a too) there may be transfer gears 1033—see FIG. 9 in which various parts shown in FIG. 8 have been removed-provided as part of the drive cassette 103bb (inwardly being towards the elevator car 101 and, in particular, the transportation compartment 101a). The transfer gears 1033 may be mounted to the pinion shafts and there may be one transfer gear 1033 for each pinion shaft. The transfer gears 1033 may be mounted for rotation with their pinion shaft. Accordingly, rotation of a transfer gear 1033 may cause rotation of the pinion shaft on which it is mounted and this may, in turn, cause rotation of the pinion 103b mounted on that pinion shaft.

In some versions, the main body 1032 includes an intermediate plate 1032a (see FIG. 8 in which that plate 1032a is present and FIG. 9 in which the intermediate plate 1032a and pinions 103b have been removed) and that intermediate plate 1032a may be located between the pinions 103b and the transfer gears 1033. Bearings may be provided (e.g. in relation to each pinion shaft) mounted to the intermediate plate, with the pinion shafts passing through the intermediate plate 1032a via the bearings.

The transfer gears 1033 may be of a different size and/or shape to the pinions 103b, but may be the same size and shape as each other. The transfer gears 1033 are configured such that they do not engage each other.

One or more idler gears 1034 (see FIG. 9 which depicts one idler gear 1034 and a second idler gear 1034 has been removed from the lowermost position for clarity of the drawing) may be provided as part of the drive cassette 103bb. In the example depicted, there are three pinions 103b and three transfer gears 1033, along with two idler gears 1034 (although only one is depicted in FIG. 9). If there were two pinion gears 103b and two transfer gears 1033, then there may be one idler gear 1034. If there were four pinion gears 103b and four transfer gears 1033, then there may be three idler gears 1034. In other words, there may be one less idler gear 1034 than there are pinion gears 103b and transfer gears 1033. In some versions, however, an idler gear arrangement is provided instead of one idler gear 1034, with the idler gear arrangement including a plurality of gears configured to perform the same function as the idler gear 1034 as described herein.

The or each idler gear 1034 is located inwardly of the pinions 103b (again, inwardly is towards the elevator car 101 and, in particular, the transportation compartment 101a) and may be generally in the same plane as the transfer gears 1033, such that the transfer gears 1033 and idler gears 1034 are configured to engage as described herein. In particular, in some versions, each idler gear 1034 is configured to engage two transfer gears 1033 such that rotation of one of these transfer gears 1033 will cause rotation of the idler gear 1034, which will in turn cause rotation of the other of these transfer gears 1033. In the depicted example, therefore, with three transfer gears 1033 and two idler gears 1034, rotation of one of the transfer gears 1033 will cause rotation of both idler gears 1034, which will in turn cause rotation of the other two transfer gears 1033. The same may be true for versions with other numbers of transfer gears 1033. As described above, each idler gear 1034 may be provided as an idler gear arrangement (i.e. including a plurality of gears configured to perform the same function as the idler gear 1034) and the description should be construed accordingly. Engagement of gears, as used herein, is a reference to the gears meshing such that rotation of one of the engaged gears (in a pair of engaged gears) will cause rotation of the other of the engaged gears (of the pair).

In some versions, the idler gear arrangement is provided using one or more belts and pulleys and/or chains and sprockets, rather than one or more gears. The use of one or more gears, however, may provide for quieter and/or more reliable operation.

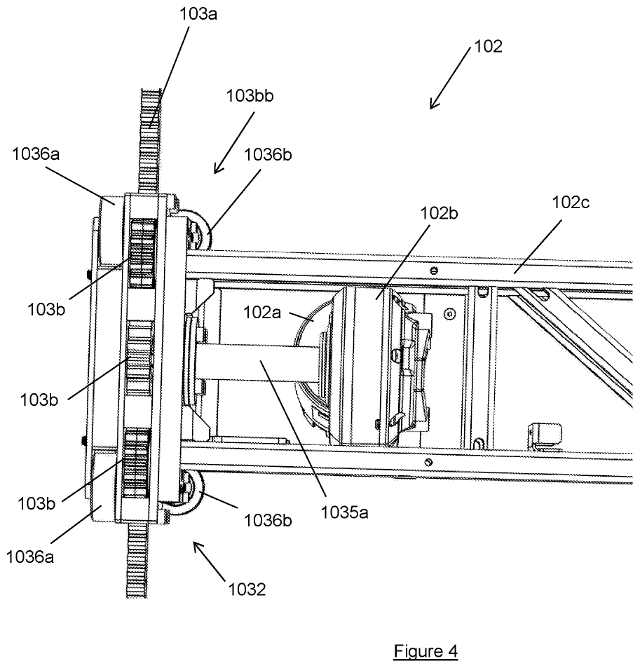

In some versions, therefore, at least one (and in some instances just one (i.e. one and only one (a “single”))) pinion shaft 1035a on which a transfer gear 1033 is mounted may be coupled to an elevator drive motor 102a of the elevator drive mechanism 102 such that the elevator drive motor 102a is configured to drive rotation of the pinion shaft 1035a and the transfer gear 1033 mounted on that pinion shaft. In some versions, there may or may not be a pinion 103b mounted to that pinion shaft 1035a (and it should be noted, therefore, that not all pinion shafts necessarily include a pinion gear 103b mounted thereon and such pinion shafts might, therefore, be referred to as transfer shafts 1035b). There may, as such, be a driven pinion shaft 1035a and transfer gear 1033, and there may be a driven pinion 103b (i.e. the pinion 103b mounted to the drive pinion shaft 1035a, if provided). In the depicted example of FIG. 8, for example, the driven pinion shaft 1035a is the middle one of the three pinion shafts). There may, therefore, be a mechanical coupling between the driven pinion shaft 1035a and the elevator drive motor 102a which is configured to transfer rotational movement to the driven pinion shaft 1035a. This mechanical coupling may include a gearbox 102b which is configured to be mounted to an output shaft of the elevator drive motor 102a and to the driven pinion shaft 1035a. The driven pinion shaft 1035a may, therefore, extend inwardly beyond the confines of the main body 1032 of the drive cassette 103bb and the elevator drive motor 102a may be located inwardly of the drive cassette 103bb—see FIG. 4 or 6, for example.

The pinion shafts may, therefore, include the driven pinion shaft 1035a and one or more transfer pinion shafts 1035b. As already described, rotation of one of the pinion shafts-through the use of the transfer gears 1033 and idler gear(s) 1034—may cause rotation of one or more others of the pinion shafts. Therefore, in versions in which there is more than one pinion 103b provided (such as the depicted example of FIGS. 3-9 which has three pinions 103b), the elevator drive motor 102a may be configured to drive rotation of a plurality of the pinions 103b of the drive cassette 103bb.

In some versions, there may be one or more freewheeling pinions of the pinions 103b. A freewheeling pinion may be mounted on a pinion shaft as described herein, however, there may be no transfer gear 1033 and/or idler gear 1034 provided to transfer rotational movement to the pinion shaft on which the freewheeling pinion is mounted. Instead, the freewheeling pinion 103b may be free to rotate.

As will be understood, the transfer gears 1033 and idler gear(s) 1034 form a mechanical coupling between the driven pinion 103b and/or driven pinion shaft 1035a and the other pinion(s) 103b. This mechanical coupling could take different forms (e.g. such as through the use of belt(s) or chain(s) as described herein).

As described, the main body 1032 of the drive cassette 103bb may include an intermediate plate 1032a which may be located between the pinions 103b and the transfer gears 1033. The pinions 103b may, therefore, be provided in a common plane to one side of the intermediate plate 1032a and the transfer gears 1033 (and potentially also the idler gears 1034) may be provided in another plane (parallel to the common plane of the pinions 103b) to another side of the intermediate plate 1032a. The intermediate plate 1032a may be located inwardly of the pinions 103b and, therefore, outwardly of the transfer gears 1033 (and potentially also the idler gears 1034)—again, inwardly and outwardly are relative to the location of the elevator car 101 and, in particular, the transportation compartment 101a.

The main body 1032 may include an inner plate 1032b (see FIG. 9) which may be located inwardly of the transfer gears 1033. The inner plate 1032b may have secured thereto bearings to which the pinion shafts 1035a, 1035b may be mounted. The driven pinion shaft 1035a may extend through the inner plate 1032b (e.g. towards the elevator drive motor 102a and/or gearbox 102b (e.g. inwardly)). The inner plate 1032b may be configured for mounting to a frame 102c of the elevator drive mechanism 102a—e.g. through the use of one or more bolts. In some versions the intermediate 1032a and/or outer plate 1032c may be configured for mounting to a frame 102c of the elevator drive mechanism 102a—e.g. through the use of one or more bolts.

The inner plate 1032b may include one or more spacers or projections to enable the attachment of the intermediate plate 1032a to the inner plate 1032b whilst providing space for the transfer gears 1033 and idler gear(s) 1034 to be mounted therebetween (and permitted to rotate with respect to the main body 1032).

When the drive cassette 103bb is mounted to the rack 103a, the pinions 103b may be located on a first side of the rack 103a such that the teeth of the rack 1031a engage the teeth 1031b of the pinions 103b. This may also mean that the transfer gears 1033 are also generally located to the first side of the rack 103a. the idler gear(s) 1034 may be offset from the transfer gears 1033 and may, therefore, be located to the first side of the rack 103a (at a greater distance than the transfer gears 1033) or may be located (as depicted in FIG. 9, for example) towards a second side of the rack 103a (the second side opposing the first side of the rack 103a). However, in some versions (such as in FIG. 9) the idler gear(s) 1034 are not in the same plane as the pinions 103b and so the rack 103a. Accordingly, the idler gear(s) 1034 may be located adjacent the rack 103a without interference therewith—to provide a compact design (as depicted in FIG. 9).

As such, the drive cassette 103bb may be mounted to the rack 103a and driven along a length of the rack 103a. It has been found that having multiple pinions 103b driven in this manner (e.g. with a single elevator drive motor 102a) provides relatively quiet and low vibration operation. Moreover, the provision of a drive cassette 103bb may enable replacement of the drive cassette 103bb as a unit—e.g. with offsite refurbishment of the drive cassette 103bb—to simplify maintenance and reduce maintenance time on-site.

The drive cassette 103bb may include additional components configured to retain engagement of the pinions 103b and the rack 103a. These additional components may include one or more rollers 1036a,b, which may be freewheeling rollers (i.e. which are free to rotate with respect to the main body 1032 of the drive cassette 103bb).

The one or more rollers 1036a,b may include one or more first rollers 1036a which may be configured to engage one or more of a surface of the channel member 103 in which the rack 103a is mounted and/or the rack 103a. In particular, the one or more first rollers 1036a may have respective axes of rotation which are parallel with the axes of rotation of the pinions 103b. The one or more first rollers 1036a may include at least one first roller 1036a which is configured to engage either the rack 103a on a part or side thereof opposite the side with the teeth 1031a and/or a part of the channel member 103 (which may be the protrusion thereof, to which the rack 103a may be mounted). In some versions (such as depicted) there may be more than one such first roller 1036a spaced apart along a length of the drive cassette 103bb. There may be one or more further first rollers 1036a provided to engage a part of the channel member 103 generally on the side thereof adjacent the teeth 1031a of the rack 1031a and, again, there may be more than one such first roller 1036a spaced apart along a length of the drive cassette 103bb. Accordingly, there may be first rollers 1036a provided on both sides of the rack 103a (e.g. on a side adjacent the rack teeth 1031a and the opposing side). These one or more first rollers 1036a may be configured to inhibit movement of the pinions 103b out of engagement with the rack 103a, and/or to reduce vibration in a plane generally parallel to the rack-and-pinion arrangement. The or each first roller 1036a may, for example, be a nylon roller or wheel.

In some versions, the drive cassette 103bb may include an outer plate 1032c (see FIG. 7) as part of the main body 1032 which is located outwardly of the intermediate plate 1032a and spaced apart therefrom by one or more spacers. At least one first roller 1036a (e.g. a first roller 1036a on the teeth 1031a side of the rack 103a) may be mounted to the outer plate 1032c. In some versions, a spacer may be mounted to the outer plate 1032c and may carry a roller mount plate 1032d (of the main body 1032) to which the at least one first roller 1036a may be mounted (the roller mount plate 1032d being outwardly located relative to the outer plate 1032c).

In some versions, at least one first roller 1036a may be provided mounted to the intermediate plate 1032a (e.g. this at least one first roller 1036a may be on the side of the rack 103a opposite the teeth 1031a). In some versions, a spacer may be mounted to the intermediate plate 1032a and may carry a roller mount plate 1032d′ (of the main body 1032) to which this at least one first roller 1036a may be mounted (this roller mount plate 1032d′ being outwardly located relative to the intermediate plate 1032a).

As will be understood, in versions with a plurality of first rollers 1036a may have first rollers 1036a with rotational axes which are parallel with each other. However, the first rollers 1036a may not all be provided in the same plane as each other, such that one first roller 1036a may be in an offset plane with respect to another first roller 1036a. At least one first roller 1036a (e.g. an inwardly located first roller 1036a) may be provided generally in the same plane as the pinions 103b. At least one first roller 1036a may be located outwardly of the pinions 103b.

Accordingly, in some versions, a first part of the drive cassette 103b may include a stack of gears and roller(s). The stack may include the transfer gears 1033 and idler gear(s) 1034 (most inwardly located in the stack (e.g. in a first layer of the stack)). The stack may include the pinions 103b (located outwardly of the transfer gears 1033 (e.g. in a second layer of the stack)). The stack may include one or more first rollers 1036a as part of the same layer of the stack as the pinions 103b. The stack may include one or more first rollers 1036a (located outwardly of the pinions 103b (e.g. in a third layer of the stack)). Not all layers of the stack may be provided on both sides of the rack 103a. So, for example as depicted, to one side of the rack 103a (e.g. the side with the teeth 1031a) there may be three layers of the stack and to the other side of the rack 103a there may be two layers of the stack. In some versions, the transfer gears 1033 and/or idler gear(s) 1034 may be provided outwardly of the pinions 103b.

The drive cassette 103bb may include one or more second rollers 1036b (best seen in FIGS. 4 and 6, for example) which have respective rotational axes which are generally perpendicular to the rotational axes of the one or more of the first rollers 1036a and/or the pinions 103b. The or each second roller 1036b may be configured, for example, to engage a part of the rack 103a and/or the channel member 103 to which the rack 103a is mounted. In some versions, such as depicted, the of each second roller 1036b may be configured to engage an inner edge or side of the rack 103a. This may be a side which is adjacent the side of the rack 103a with the teeth 1031a, for example. The or each second roller 1036b may be located generally inwardly of the rack 103a. The rotational axes of the or each second roller 1036b may be generally aligned with the transfer gears 1033 (e.g. the first layer of the stack). The or each second roller 1036b may be configured to run along a length of the rack 103a.

In some versions, the or each second roller 1036b may be mounted to the inner plate 1032b, the intermediate plate 1032a, and/or one or more spacers located between the inner and intermediate plates 1032a,b.

The or each second roller 1036b may include a plurality of second rollers 1036b which may be spaced apart along a length of the drive cassette 103bb. The second rollers 1036b may be provided in a common plane and may have parallel axes of rotation. There are, for example, two such second rollers 1036b provided in the version depicted in FIGS. 4 and 6.

The or each second roller 1036b may be a nylon roller, for example.

The or each second roller 1036b may be configured to inhibit movement of the drive cassette 103bb outwardly (towards the rack 103a).

As will be appreciated, the or each roller 1036a,b may be configured to inhibit rotational movement of the elevator drive mechanism 102 with respect to the rack 103a—particularly when there are two racks 103a each of which is associated with a respective drive cassette 103bb.

As described, the drive cassette 103bb may be mounted to the frame 102c of the elevator drive mechanism 102. In the depicted and some other versions, a drive cassette 103bb is provided in relation to each rack 103a which is provided as part of the elevator system 100. This may be two racks 103a, for example, which may be provided on opposing sides of the elevator system 100 and/or elevator car 101 and/or elevator drive mechanism 102. Each drive cassette 103bb may be a drive cassette 103bb as described herein. The precise configuration of one drive cassette 103bb of the elevator drive mechanism 102 may differ from that of another drive cassette 103bb of the same elevator drive mechanism 102 or there may be two or more substantially identically configured drive cassettes 103bb provided.

In the depicted and some other examples of FIGS. 3-9, the rack 103a may have teeth 1031a which face forwardly (i.e. generally in the direction of the door of the transportation compartment 101a (or other aperture through which that compartment 101a is accessed)) or backwardly (i.e. generally in the direction away from the door of the transportation compartment 101a (or other aperture through which that compartment 101a is accessed)). However, other configurations are envisaged with the drive cassette(s) 103bb being mounted in a corresponding orientation.

The frame 102c of the elevator drive mechanism 102 may include one or more beams which may extend across a width of the elevator drive mechanism 102 and/or the elevator car 101. Components of the elevator drive mechanism 102 may be mounted to the frame 102c and the transportation compartment 101a may be supported by the frame 102c. For example, the transportation compartment 101a may be mounted above the frame 102c, the transportation compartment 101a may be secured beneath the frame 102c (e.g. rigidly or suspended therefrom by a flexible coupling).

As described, the elevator drive mechanism 102 includes at least one elevator drive motor 102a and there may be one elevator drive motor 102a provided in association with each drive cassette 103bb in versions with multiple drive cassettes 103bb. The or each elevator drive motor 102a may have an output shaft which is coupled, e.g. via the gearbox 102b, to the associated drive cassette 103bb and, in particular, to the driven pinion shaft 1035a thereof. The gearbox 102b may translate the speed of rotation of the output shaft of the elevator drive motor 102a to a lower rotational speed of the driven pinion shaft 1035a, for example. The gearbox 102b may be a right-angled gearbox 102b, such that a rotational axis of the output shaft of the elevator drive motor 102a may be perpendicular to the axis of rotation of the driven pinion shaft 1035a. This may allow for a compact design—e.g. as depicted. The or each elevator drive motor 102a may be mounted such that the output shaft(s) thereof extend forwardly or backwardly.

The pinions 103b, and/or the transfer gears 1033, and/or the idler gear(s) 1034 could take a number of different forms. In some versions, one or more of these gears is a spur gear or a helical gear

The elevator drive mechanism 102 may include a control system 102d which is configured to control the operation of the elevator drive motor(s) 102a—e.g. providing electrical power thereto in a controlled manner. The elevator drive mechanism 102 may include a battery 102e, and the control system 102d may be configured to use electrical power from the battery 102e to power operation of the elevator drive motor(s) 102a—which may, therefore, be electrically operated.

As discussed, the above versions have been described with reference to a rack 103a but may be used with other forms of rail 103a (of which a rack 103a is an example).

Further versions are described with more particular reference to FIGS. 11-20, and in these versions the rack 103a is referred to as a rail 103a but still provides a rack 103a.

For example, therefore, some versions may include a rail 103a which has a generally circular cross-section and which includes teeth 1031a arranged along a length thereof. In some versions, these teeth extend around only part of the circumference of the rail 103a and may be provided around a linear portion of that circumference (e.g. through a length of the rail 103a generally facing in the same direction). Whilst this will be referred to as a side of the rail 103a (the side of the rail 103a with teeth 1031a) it will be appreciated that this side may, in fact, be a portion of the circumference of the circular cross-section of the rail 103a. The rail 103a may, therefore, have a toothed portion extending linearly along the rail (with the teeth 1031a generally arranged perpendicular to a longitudinal axis of the rail 103a) and an untoothed portion also extending linearly along the rail. The toothed portion may be less than half the circumference of the cross-section of the rail 103a. The toothed portion may represent an inwardly facing part of the rail 103a. The untoothed portion may represent an outwardly facing portion of the rail 103a. In some versions, the toothed portion extends to encompass the outwardly facing portion of the rail 103a and, in some versions, the teeth 1031a extend around substantially the entire (or the entire) circumference of the rail 103a. In some versions, the toothed portion may face forwardly or backwardly or outwardly (again, these terms have the same meaning throughout (e.g. relative to the position of the elevator car 101 and transportation compartment 101a and with reference to the side through which access to the transportation compartment 101a is possible)).

The rail 103a may be configured to be mounted to a respective channel member 103. There may be more than one channel member 103 provided and each channel member 103 may have a respective rail 103a mounted thereto.

The untoothed portion and/or the outwardly facing portion of the rail 103a may include one or more mounting locations for a bracket for use in mounting the rail 103a to the channel member 103. The or each mounting location may be a threaded aperture, for example, configured to receive a bolt which may be used in securing the bracket to the rail 103a. The bracket may extend from the rail 103a over a relatively small portion of the circumference of the rail 103a. In some versions, as mentioned above, the rail 103a may be supported by its ends and not mounted to the channel member 103.

In some versions, the pinion 103b (best seen in FIG. 16 and also visible in FIG. 15) is configured to engage the rail 103a. The pinion 103b may have an axis of rotation which is perpendicular to the direction of extension of the rail 103a. In some versions, the axis of rotation of the pinion 103b is forwardly or backwardly directed. In some versions, the axis of rotation of the pinion 103b is perpendicular to a width of the elevator drive mechanism 102.

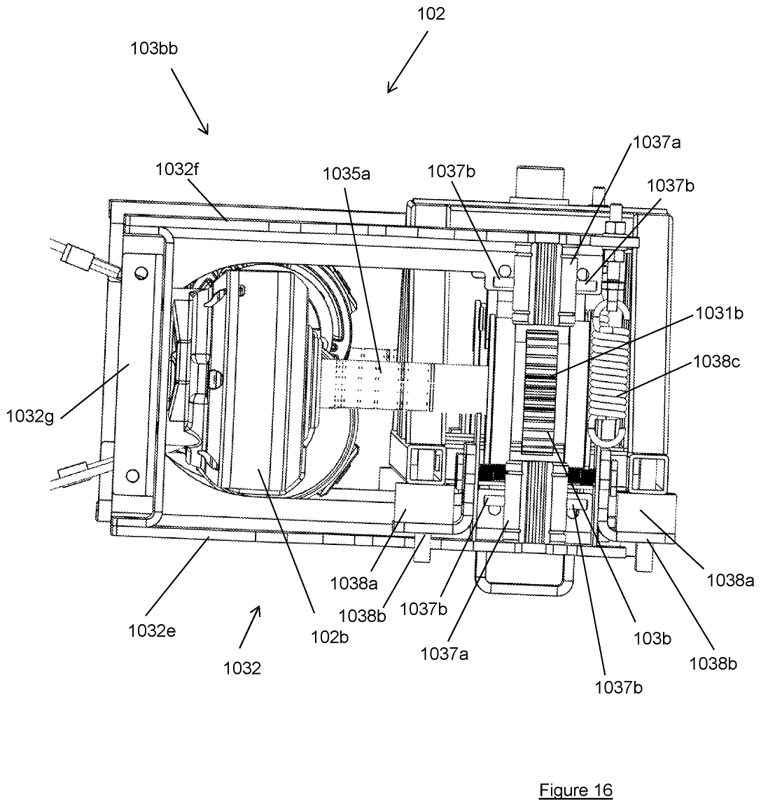

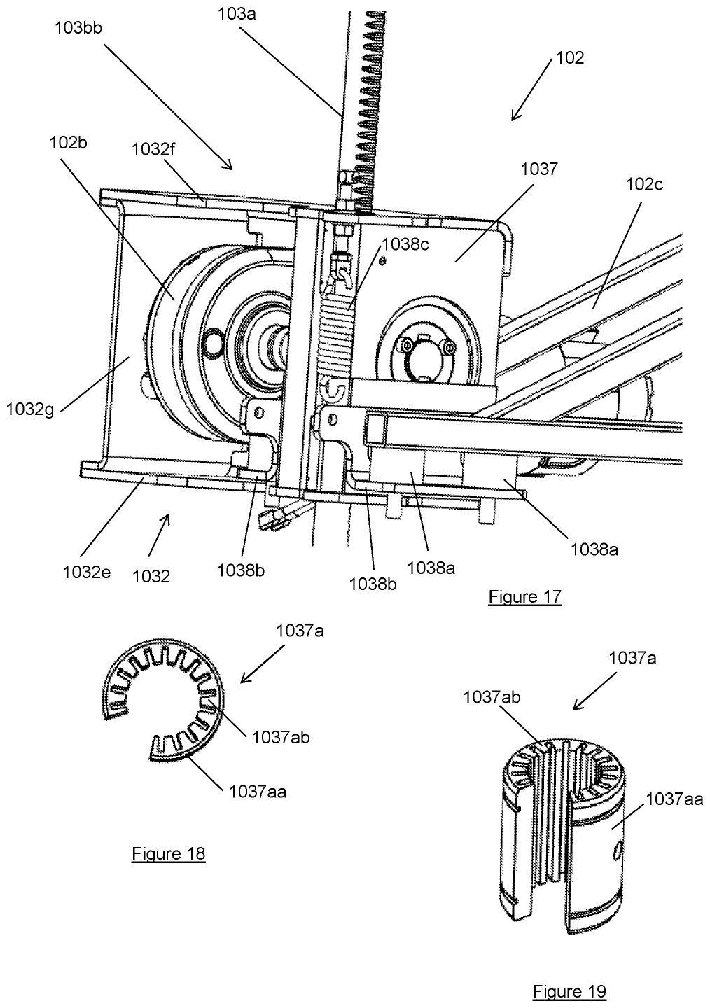

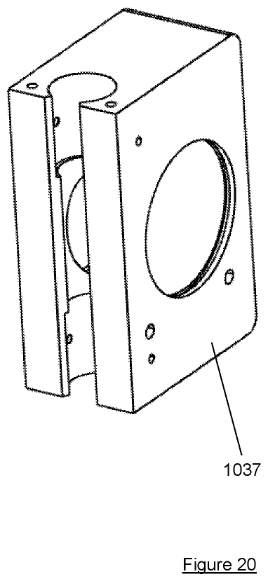

As described herein, the pinion 103b may be part of a drive cassette 103bb. The drive cassette 103bb may, also as described herein, include the main body 1032. In this and some other versions, the main body 1032 may include a bearing block 1037—see FIGS. 17 and 20 (FIG. 20 shows the bearing block in isolation), for example, and note that the bearing block 1037 has been removed from FIGS. 15 and 16. The bearing block 1037 may be configured to carry (i.e. support) one or more bearings of the drive cassette 103bb. These one or more bearings may include one or more bearings which support the pinion shaft (which may be a driven pinion shaft 1035a) on which the pinion 103b is mounted (and, for example, with which the pinion 103b is configured to rotate). These one or more bearings may include one or more linear bearings 1037a configured to engage at least part of the rail 103a (the linear bearings 1037a are shown in isolation in FIGS. 18 and 19, and in the position they would take (supported by the bearing block 1037) in FIGS. 15 and 16 even though the bearing block 1037 has been removed in these figures).

The or each linear bearing 1037a may include a collar 1037aa. The collar 1037aa may have a generally circular outer cross-sectional shape but may not form a complete circle such that a linear gap is provided and the collar 1037aa has a c-shaped cross-sectional shape. From the collar 1037aa there may be a plurality of inward extensions 1037ab (e.g. fins) which may extend inwardly from the collar 1037ab (e.g. radially inwardly). The inner ends of the extensions 1037ab may define a tube-like channel which may be configured to receive the rail 301a (this tube-like channel may eb defined by elongate ends of the inward extensions 1037ab). Accordingly, the or each linear bearing 1037a may be configured to fit around the rail 301a. The collar 1037aa may be held in place by the bearing block 1037 and the collar 1037aa may include one or more channels or protrusions (such as a circumferential channel) around its outer surface to help to keep the collar 1037aa in place with respect to the bearing block 1037 (e.g. inhibiting linear movement of the linear bearing 1037a with respect to the bearing block 1037). One or more pins 1037b may be provided which extend through at least part of the bearing block 1037 and into the collar 1037aa. The or each pin 1037b may inhibit rotational movement of the linear bearing 1037a with respect to the bearing block 1037.

The or each linear bearing 1037a may fit around the rail 103a in the bearing block 1037 such that the bearing block 1037 is slidable along a length of the rail 103a with the rail 103a passing through the or each linear bearing 1037a. The extensions 1037ab of the or each linear bearing 1037a may allow such movement and inhibit unwanted lateral movement of the bearing block 1037 with respect to the rail 103a. In some versions there may be at least two such linear bearings 1037a provided and these may be spaced apart so that they engage different parts of the rail 103a at any given instance (i.e. different parts along a length of the rail 103a). In some versions, the pinion 103b is generally located between the two linear bearings 1037a (i.e. such that the pinion 103b engages a portion of the rail 103a between the two linear bearings 1037a).

In some versions, the bearing block 1037 may be provided as a framework of beams. Accordingly, the bearing block 1037 may be referred to more generally as a bearing carrier 1037. In some versions, one or more bearings to support the pinion shaft 1035a may be supported by another part of the main body 1032 of the drive cassette 103bb.

The drive cassette 103bb main body 1032 may include a frame which may be formed from beams and/or panels. In the depicted and some other versions, the frame includes a plurality of panels. These panels may include a first (or bottom) panel 1032e, a second (or top) panel 1032f, and a first side panel 1032g. The first panel 1032e and second panel 1032f may be generally parallel with each other and may both be attached to the side panel 1032g (which may be perpendicular to the first and/or second panels 1032a,f). The side panel 1032g may serve, therefore, to separate the first and second panels 1032e,f. The gearbox 102b may be mounted to the side panel 1032g in some versions. The elevator drive motor 102a may be mounted to the gearbox 102b and so this may also provide the mounting of the motor 102a to the elevator drive mechanism 102.

The side panel 1032f may be located generally at one end of the first and second panels 1032e,f. Another end of the first and second panels 1032e,f may be mounted to the bearing block 1037 which may be located generally opposite the side panel 1032g.

The first and second panels 1032e,f along with the side panel 1032g and bearing block 1037 may form a box-like structure.

The drive cassette 103bb may be mounted to the frame 102c of the elevator drive mechanism 102 by a flexible mounting mechanism which is configured to dampen vibration and inhibit its transmission between the drive cassette 103bb and the frame 102c. The flexible mounting mechanism may also allow for continued operation of the elevator car 101 even if the elevator car 101 and/or elevator drive mechanism 102 is not perfectly level.

The flexible mounting mechanism may include one or more cushioned mounting blocks 1038a—such as rubber (or synthetic rubber) blocks positioned between a flexible mounting mechanism bracket 1038b and the frame 102c. The or each cushioned mounting block 1038a may include an annular block (which may be waisted) through which a pin is located, the pin passing through a portion of the flexible mounting mechanism bracket 1038b and the frame 102c and allowing movement of the frame 102c linearly along the pin towards and away from the flexible mounting mechanism bracket 1038b. The or each cushioned mounting block 1038a may be located such that, in normal use, at least part of the weight of the elevator drive mechanism 102 (and any transportation compartment 101a supported thereby) presses the frame 102c onto the or each cushioned mounting block 1038a. In some versions, there may be two or more (e.g. four) cushioned mounting blocks 1038a. In some versions, one or more cushioned mounting blocks 1038a are associated with one flexible mounting mechanism bracket 1038b and there may be more than one flexible mounting mechanism bracket 1038b.

The flexible mounting mechanism bracket 1038b may have an L-shaped cross-section and the or each cushioned mounting blocks 1038a which are supported by that bracket 1038b may be located on a generally horizontal part (i.e. lower part) of the bracket 1038b (e.g. with the pin(s) passing through the generally horizontal part).

The generally vertical part (i.e. upper part) of the flexible mounting mechanism bracket 1038b may extend, therefore, to one side of the or each cushioned mounting block 1038a supported by that bracket 1038b. The generally vertical part of the flexible mounting mechanism bracket 1038b may include one or more slots which extend generally vertically and which are elongate (visible in FIGS. 15 and 16). Each slot may be configured to receive a connection pin which is configured to be attached to a part of the drive cassette 103bb (e.g. to a part of the main body 1032 such as one of the panels 1032e,f,g or to part of the bearing block 1037). The connection pin may be fixed for movement with the drive cassette 103bb and may be dimensioned to be able to move along a length of the slot in which it is received in the flexible mounting mechanism bracket 1038b. Therefore, the flexible mounting mechanism bracket 1038b may be configured for vertical movement with respect to the drive cassette 103bb. In some versions a suspension spring 1038c (which may be a helical spring) is provided as part of the flexible mounting mechanism 1038b. The suspension spring 1038c may be configured to bias, in a resilient manner, the flexible mounting mechanism bracket 1038b towards at least part of the drive cassette 103bb. This may be, in the depicted and some other versions, biasing the flexible mounting mechanism bracket 1038b upwardly. This may be, in the depicted and some other versions, biasing of the flexible mounting mechanism bracket 1038b in a direction towards the frame 102c and this may be such that the flexible mounting mechanism bracket 1038b is pressed into the or each cushioned mounting block 1038a with which it is associated. As will be understood, therefore, the or each cushioned mounting block 1038a may be sandwiched between the flexible mounting mechanism bracket 1038b with which it is associated and the frame 102c.

In some versions, the suspension spring 1038c may be mounted at one end to an eyelet which is secured to the second panel 1032f and at an opposing end to an eyelet which is defined by the flexible mounting mechanism bracket 1038b. It should be noted that FIGS. 12-17 show the suspension spring 1038c not mounted to the eyelet of the flexible mounting mechanism bracket 1038b (which can be seen immediately below a hooked end of the suspension spring 1038c).

As depicted and in some other versions, there may be more than one flexible mounting mechanism bracket 1038b and, in some versions, there is a first flexible mounting mechanism bracket 1038b provided on one side of the rail 103a and a second flexible mounting mechanism bracket 1038b on the opposing side of the rail 103a (e.g. with one flexible mounting mechanism bracket 1038b forward of the rail 103a and the other flexible mounting mechanism bracket 1038b rearward of the rail 103a). In the depicted and some other versions, each flexible mounting mechanism bracket 1038b is associated (i.e. supports) one or two (or more) cushioned mounting blocks 1038a. These cushioned mounting blocks 1038a may be arranged in an array extending inwardly, for example, and the outermost cushioned mounting block 1038a may be generally aligned with the rail 103a in some versions. Accordingly, the first and second flexible mounting mechanism brackets 1038b may be arranged in parallel with each other and this may be such that the generally vertical parts thereof face towards each other-with the rail 103a being between the two flexible mounting mechanism brackets 1038b in some versions.

The flexible mounting mechanism 1038b may, therefore, allow for some movement between the frame 102c and the drive cassette 103bb (which may be damped by the flexible mounting mechanism 1038b).

The frame 102c may include one or more beams and these may include a first beam which extends parallel to the first flexible mounting mechanism bracket 1038b and a second beam which extends parallel to the second flexible mounting mechanism bracket 1038b, with the two beams of the frame 102c located generally adjacent a respective one of the first and second flexible mounting mechanism brackets 1038b. The cushioned mounting blocks 1038a may, therefore, abut their associated flexible mounting mechanism bracket 1038b and one of the two beams of the frame 102c.

As with other versions, the arrangement may be replicated in relation to the or each rail 103a and there may be a rail 103a located on each of two opposing sides of the elevator drive mechanism 102 and/or elevator car 101.

In some versions, the frame 102c includes a trelliswork frame. In some versions, the transportation compartment 101a is suspended from the frame 102c and this may be achieved through the use of one or more straps 102f (see FIGS. 12 and 14). The or each strap 102f may be an endless strap 102f which extends around a part of the frame 102c and a part of the structure of the transportation compartment 101a. In some versions, the or each strap 102f may be replaced by a pneumatic or hydraulic damper. In some versions, the frame 102c may be rigidly connected to the transportation compartment 101a.

In some versions, the frame 102c includes the two beams discussed above which may extend generally parallel with each other and spaced apart from each other. In some versions, generally at the midpoint along the length of the two beams the frame 102c may include boxwork which may include one or more upright beams extending perpendicular to the two beams (and which may extend away from the transportation compartment 101a. Distal ends of the upright beams, in versions with a plurality of such beams, may be connected together (i.e. the distal end of one upright beam may be connected to the distal end of at least one other upright beam) by one or more upper beams which may be in a parallel plane to the two beams and which may be perpendicular to the two beams. One or more inclined beams may extend from the distal end or ends of the one or more upright beams to one of the two beams, for example.

In some versions, one or more further rollers 101ab may be provided which are coupled to the transportation compartment 101a (e.g. to a part of the structure thereof) and/or to the elevator drive mechanism 102 and which are configured to rotate with respect thereto. The or each further roller 101ab may be configured to engage a part of at least one of the channel members 103 as the elevator car 101 moves along a length of the channel members 103.

In some versions, the one or more further rollers 101ab may extend outwardly from the elevator car 101. In some versions one or more further rollers 101ab may be provided on either side of the rail 103a. In some versions, the one or more further rollers 101ab may extend forward or rearward from the elevator car 101. In some versions, the one or more further rollers 101ab may extend forward or rearward from the elevator car 101 and outwardly from the elevator car 101.

The one or more further rollers 101ab may be freewheeling rollers.

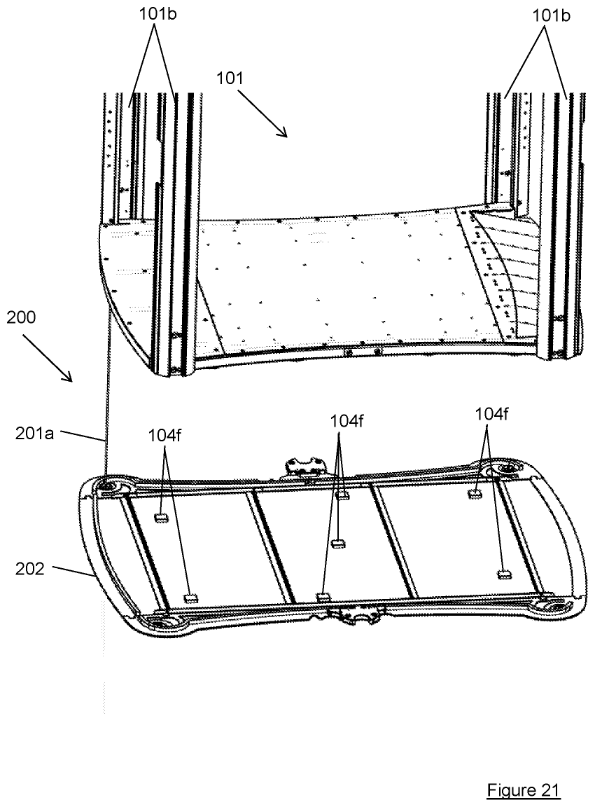

Some versions may include a fire seal system 200 (see FIGS. 21-24, for example) which may be part of the elevator system 100 and which may be part of the elevator car 101 in some versions (or parts of the fire seal system 200 may be part of the elevator car 101).

The fire seal system 200 includes two or more cable spools 201. Each cable spool 201 may be located above the transportation compartment 101a and may be located in the elevator drive mechanism 102. However, in some versions, each cable spool 201 is located underneath the transportation compartment 101a.

Each cable spool 201 is provided with a respective cable 201a which the cable spool 201 is configured to collect (e.g. around a part of the cable spool 201) and release (e.g. from that part of the cable spool 201). Accordingly, a proximal part of each cable 201a may be coupled to the cable spool 201. A distal part of each cable 201a may be secured to a fire seal member 202 of the fire seal 200. The fire seal member 202 may be in the form of a plate which is sized to cover an aperture through a ceiling or floor through which the elevator car 101 is configured to pass. The distal part of each cable 201a may be secured to part of a peripheral edge of the fire seal member 202 and may be secured to a corner thereof.

In some versions, there are, therefore, at least two cables 201a which are secured to the fire seal member 202 and these may be secured at locations across a width of the fire seal member 202. In some versions, the cables 201a are secured to the fire seal member 202 and these may be distributed around the periphery of the fire seal member 202 such that the fire seal member 202 can be suspended substantially horizontally using the cables 201a. There may be three or four or more such cables 201a. In some versions, there are four such cables 201a and these are generally located at corners of the elevator car 101.

In some versions, the elevator car 101 includes frame members 101b which may be generally vertical members in normal use. Each frame member 101b may define a longitudinal channel through which one (or more) of the cables 201a is configured to pass. Each frame member 101b may, therefore, extend from above the transportation compartment 101a to below the transportation compartment 101a (e.g. with the cable spools 201 located above the transportation compartment 101a and the fire seal member 202 located beneath the transportation compartment 101a).

The cable spools 201 may be configured to release their cables 201a to allow the fire seal member 202 to move away from the transportation compartment 101a and the fire seal member 202 may be configured to make such a movement. The cable spools 201 may be configured to collect the cables 201a to retract the fire seal member 202 towards the transportation compartment 101a.

Accordingly, operation of the cable spools 201 may allow for movement of the fire seal member 202 away from and towards the transportation compartment 101a.

In some versions, each cable spool 201 may include a motor to drive its operation and, in particular, the collection and retraction of the cable 201a. A controller may be provided to synchronise the operation of the cable spools 201 to keep the fire seal member 202 generally horizontal.

In some versions, each cable spool 201 is biased to collect the cable 201a. This biasing may be achieved using a spring biased cable spool 201 for example. In some versions, the fire seal member 202 may be held against this bias such that the cables 201a are released from their cable spools 201. Release of the fire seal member 202 may allow the bias to cause the collection of the cables 201a and the retraction of the fire seal member 202.

The fire seal member 202 is configured to block the aperture through which the elevator car 101 is configured to pass in each level. This may be an aperture defined by a ceiling or a floor or both. Accordingly, in some versions, the fire seal member 202 is configured to cover the entirety of that aperture and is sized such that it cannot pass therethrough. Accordingly, as the elevator car 101, for example, travels upwardly through the ceiling and/or floor, the fire seal member 202 be in a retracted position but may then abut the ceiling and/or floor and be prevented from remaining in the retracted position by this abutment. The abutment of the fire seal member 202 may cause the release of the cables 201a from the cable spools 201 (e.g. against the bias). The cable spools 201 may operate, however, to maintain the abutment of the fire seal member 202 and the ceiling or floor (e.g. by virtue of the bias or motor control). The fire seal member 202 may, therefore, inhibit or substantially prevent (for a predetermined period of time) the passage of fire through the aperture.

As the elevator car 101 passes back down through the aperture, the cable spools 201 may collect the cables 201a and the fire seal member 202 may be retracted towards the transportation compartment as the elevator car 101 moves through the aperture.

In some versions, a second or upper fire seal member may be provided at a top of the elevator car 101 which is configured to be left behind, covering the aperture in the floor, as the elevator car 101 passes downwardly (for example, to be collected at the top of the elevator car 101 again when the elevator car 101 rises back through the aperture).

In some versions, there may be multiple fire seal members 202 provided at the bottom of the elevator car 101 and/or at the top of the elevator car 101. This may enable the elevator car 101 to pass through more levels. For the fire seal members at the top of the elevator car 101 this may be achieved by having different sized and/or shaped apertures and fire seal members—so that only one will abut on each floor.

For the fire seal members 202 at the bottom of the elevator car 101, this may be achieved by the use of multiple parallel cables 201a and with some cables 201a, for example, passing through apertures in at least one other fire seal member 202—such that independent collection and release of the cable 201a for different fire seal members 202 is possible. Apertures through fire seal members 202 for this purpose (and/or other purposes) may be provided with intumescent seals, for example. In some versions with a plurality of fire seal members 202 at the bottom of the elevator car 101, the fire seal members 202 may be of different shapes and/or sizes and configured, therefore, to abut different ones of the ceilings and floors (the apertures through which may also be of different shapes and sizes). In some versions, other arrangements may be used to retain the fire seal members 202 at the correct floor or ceiling, including—for example—one or more catch members and/or magnets (which may be electro-magnets). Such other arrangements may be provided in different locations on different ones of the fire seal members 202 and/or ceilings/floors such that the other arrangement for each tire seal member 202 forms a pair with one of the ceilings/floors—so that the fire seal member 202 for that ceiling/floor is retained in the correct location by the other arrangement for the ceiling/floor but not at another ceiling/floor. In some versions, the fire seal members 202 are daisy-chained from each other by cable spools, such that the cable spools for the lower most fire seal member 202 are located on the next lowermost fire seal member 202 and so on.

In some versions, one or more switches may be provided on the ceiling/floor which are configured to be triggered by the fire seal member 202 when the fire seal member 202 blocks the aperture therethrough. This may provide feedback to the user (e.g. a visual indication or alert) when the fire seal member 202 is in this location or when it is not in that location but, due to the location of the elevator car 101, should be in that location. The position of the elevator car 101 may be determined using optical encoders associated with the elevator drive motor(s) 102a, for example.

The or each fire seal member 202 may include one or more proximity sensors (e.g. capacitive or ultrasonic sensors) to detect the presence of objects which may obstruct the operation of the elevator car 101.

In some versions, the cable spool 201 is provided with a cable spool bracket 203 for mounting the cable spool 201 to the elevator car 101 and, for example, to the elevator drive mechanism 102 (e.g. to the frame 102c thereof). The cable spool bracket 203 may include a top plate 203a which may be configured to be mounted, for example, to the frame 102c and which may rest on the frame 102c with the cable spool 201 then positioned beneath an uppermost part of the frame 102c in some versions. The top plate 203a may be configured to be mounted to a corner section of the frame 102c and may, therefore, include parts which mount to members of the frame 102c which are perpendicular to each other. In some versions, the cable spool bracket 203, and potentially the top plate 203a, are configured to be mounted to the frame member 101b of the elevator car 101.

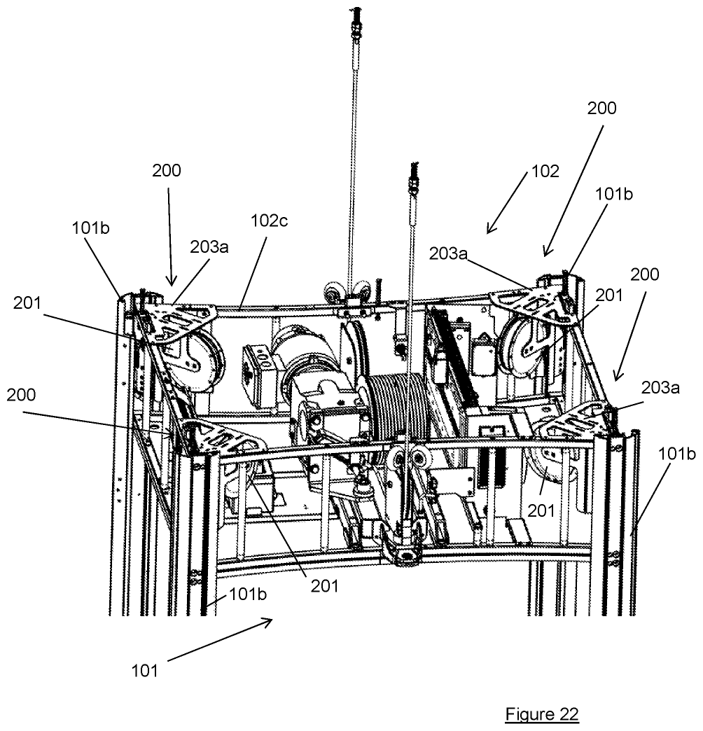

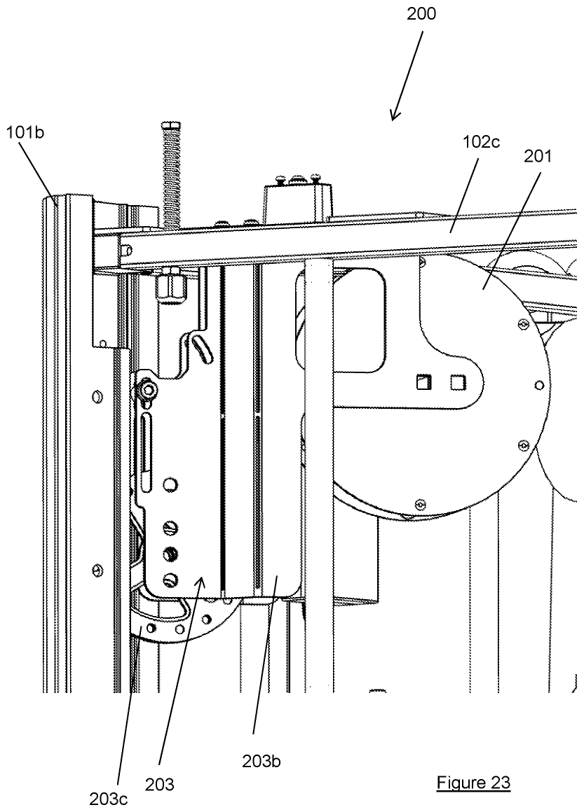

The top plate 203a may carry one or more side plates 203b to which the cable spool 201 may be mounted. FIG. 23 shows a view with the side plates 203b (of which there are two in this version) in place, whilst one of the side plates 203b has been removed in FIG. 24 for a clearer view.

The cable spool bracket 203 may also carry one or more additional pulleys 203c (see FIG. 24 in which the removed side plate 203b provides better sight of an additional pulley 203c) which are configured to direct the cable 201a from the cable spool 201 to the position in which it is desired to run (e.g. through the frame member 101b). In some versions, there is a first additional pulley 203c which is located such that its rotational axis is beneath that of the cable spool 201 and the first additional pully 203c may have a smaller diameter than the cable spool 201.

As will be understood, there may be a plurality of cable spools 201 provided for a single elevator car 101 and each cable spool 201 may be mounted as described above. In some versions, there is one cable spool 201 at each of four corners of the elevator car 101.

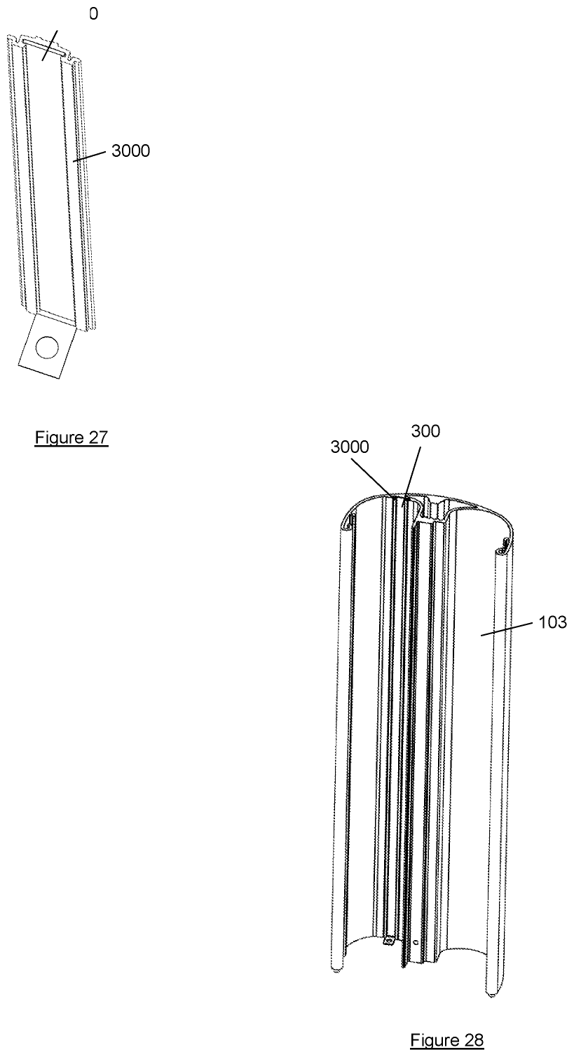

In some versions, the battery 102e (see FIGS. 26 and 11) for the operation of the elevator system 100 is carried by the elevator car 101. This battery 102e may be a rechargeable battery and, therefore, will need to be recharged to allow for continued operation of the elevator system 100. In some versions, therefore, a conductor 300 may be provided-see FIG. 27, for example. The conductor 300 may be an elongate strip and may be provided in the channel member 103. The conductor 300 may, for example, be a conductive tape which may be a copper tape. The conductive tape 300 may be provided in a conductor carrier 3000 which may be formed from a material (such as a plastics material) which is not electrically conductive.

The conductor carrier 3000 may help to support the tape 300. The conductor carrier 3000 may be sized and shaped to be received (see FIG. 28 for example) within a corresponding slot in the channel member 103 to attach the conductor 300 to the channel member 103 (and this may be such that the channel member 103 and conductor 300 are electrically isolated, e.g. so that the channel member 103 can be used as an electrical conductor along with the conductor 300 for the delivery of electrical power). An end of the conductor 300 may include a terminal tab for connection (in electrical communication) with a wire, terminal or other electrical conductor.

The elevator drive mechanism 102 may include a charging system 102g configured to receive electrical power and to recharge the battery 102e. The electrical power may be provided through the conductor 300 which may, in some versions, be in electrical communication with a positive outlet of a power supply. A negative output of the power supply may be connected in electrical communication with another such conductor 300 and/or with the rail 103a (e.g. rack 103a).

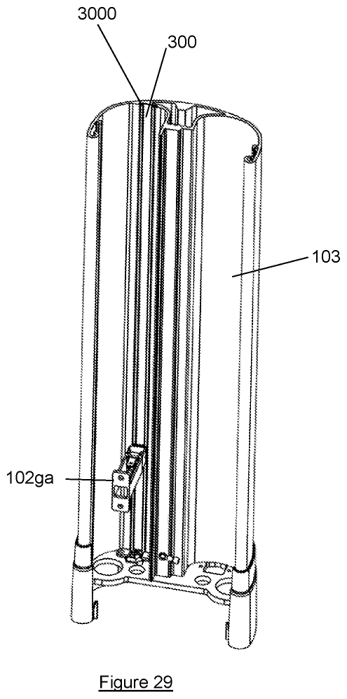

The charging system 102g may include a brush 102ga (see FIG. 29 in which the brush 102ga is shown with a channel member 103 but with various other components omitted so that the brush 102ga can be seen) which may be a carbon brush and which may be configured to engage the conductor 300. The brush 102ga may be carried by the elevator drive mechanism 102 and so may be carried by the elevator car 101. Accordingly, as the elevator car 101 moves with respect to the channel member 103, the brush 102ga may run along a length of the conductor 300.

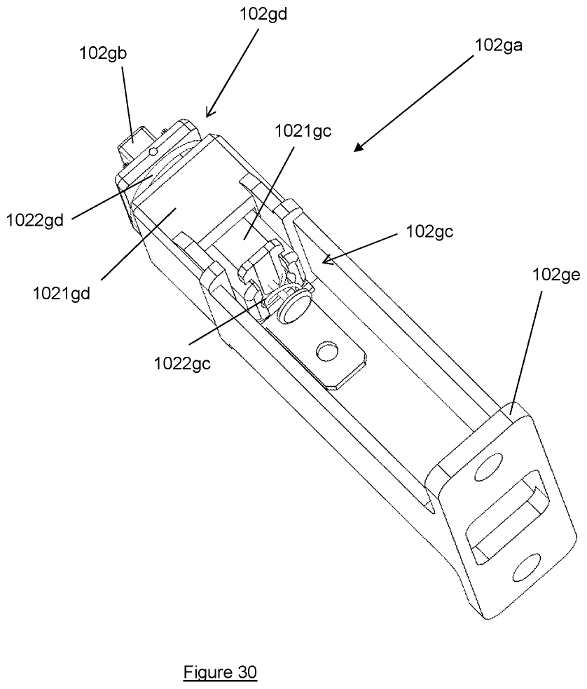

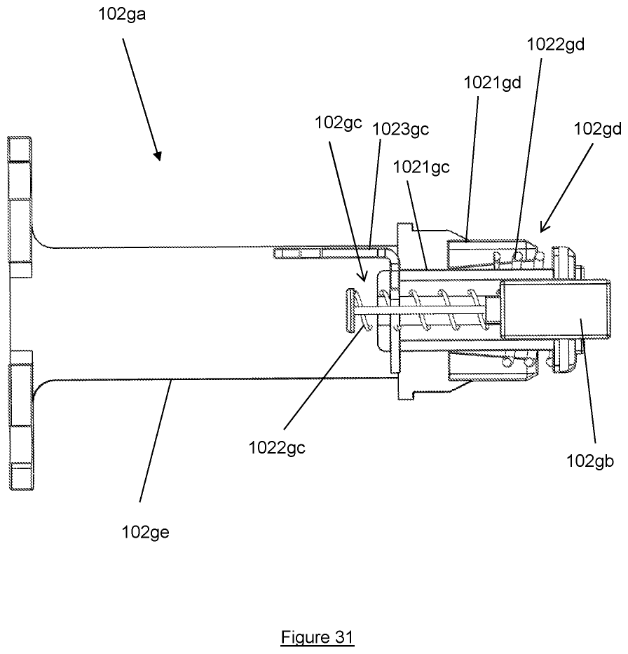

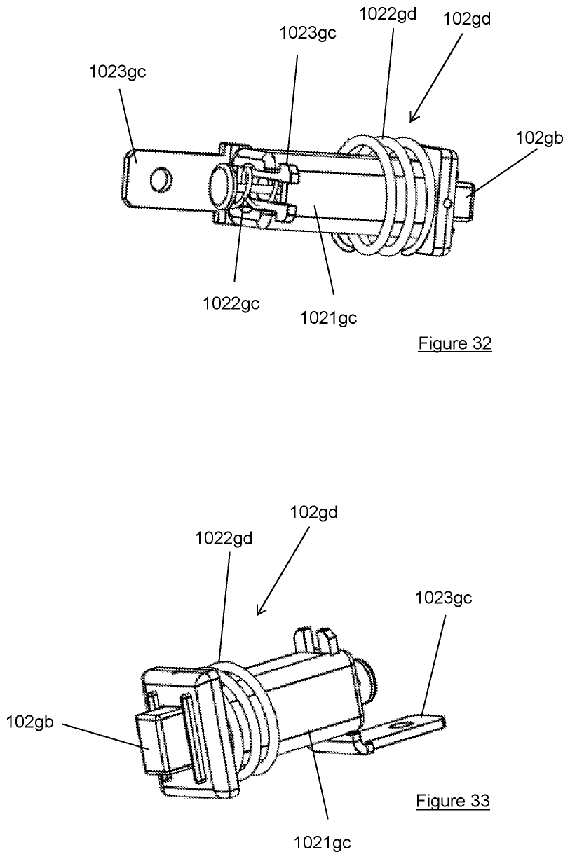

With reference to FIGS. 30-34, the brush 102ga may include a brush member 102gb which may be formed from carbon or another electrically conductive material and which is configured to engage the conductor 300. The brush 102ga may include a first biasing stage 102gc and a second biasing stage 102gd which are both configured to bias the brush member 102gb towards the conductor 300. In some versions, the first and second biasing stages 102gc, 102gd may operate telescopically with respect to each other and, in some versions, with respect to the brush member 102gb.

Accordingly, in some versions, the first biasing stage 102gc includes a first cup or collar 1021gc which receives at least part of a first spring 1022gc and at least part of the brush member 102gb. The first spring 1022gc is configured to bias the brush member 102gb outwardly from the first cup or collar 1021gc (abutment of a part of the brush member 102gb with a part (e.g. lip) of the first cup or collar 1021gc may prevent the brush member 102gb from disengaging from the first cup).

In some versions, the first cup or collar 1021gc includes a slot to receive at least part of a clip 1023gc. This slot may be provided towards an end of the first cup or collar 1021gc which opposes an end through which the brush member 102gb may extend. The clip 1023gc may be configured to be received by the slot and retained therein. The clip 1023gc may, therefore, have one or more resiliently biased members (e.g. tabs) which engage with the walls defining the slot, for example. The first cup or collar 1021gc may define a bore in which the first spring 1022gc is at least partially received and the slot and clip 1023gc may be configured to engage a part of the first spring 1022gc which extends through the bore. This may allow for the adjustment of the distance of extension of the brush member 102gb from the first cup or collar 1021gc (e.g. by removal of the clip 1023gc, adjustment of the brush member 102gb position, and then re-attachment of the clip 1023gc).

In some versions, the brush member 102gb may be mounted on a shaft around which the first spring 1022gc may be provided. The shaft may carry and end member (e.g. at an end of the shaft opposite the brush member 102gb) such that the first spring 1022gc is located between the brush member 102gb and the end member. The end member may be shaped and sized such that it cannot pass through the bore of the first cup or collar 1021gc (so retaining the brush member 102gb so that it remains at least partially received by the bore).

The clip 1023gc may include two such resiliently biased members which may extend parallel to each other. In some versions, the clip 1023gc is generally L-shaped.

The second biasing stage 102gd may include a second cup or collar 1021gd which receives at least part of a second spring 1022gd and at least part of the first cup or collar 1021gc. The second spring 1022gd is configured to bias the first cup or collar 1021gc outwardly from the second cup or collar 1021gd (e.g. by abutment of a part of the first cup or collar 1021gc with the second spring 1022gd which may also abut the second cup or collar 1021gd). The first cup or collar 1021gc may include a head member from which the brush member 102gb may extend. The head member may have a larger diameter than a shaft portion of the first cup or collar 1021gc (that shaft portion being received, at least partially, by the second cup or collar 1021gd). The head member may be sized and shaped so that the head member cannot pass into the second cup or collar 1021gd. The head member may include one or more elongate protrusions adjacent the brush member 102gb and aligned with the intended direction of travel of the brush 102ga along the conductor 300—which may space an end of the head member from the conductor 300, for example, and/or which may help to align the brush member 102gb with the conductor 300 (e.g. by abutment against the conductor carrier 3000).

There may be a brush frame member 102ge provided for securing the second cup or collar member 1021gc to another structure and the clip 1023gc may also be configured to be secured to another structure (which may the same structure). This may be achieved by the use of bolts, for example.

This concentric, telescopic, brush member 102gb has been found to provide improved and consistent electrical connection between the brush 102ga and the conductor 300.

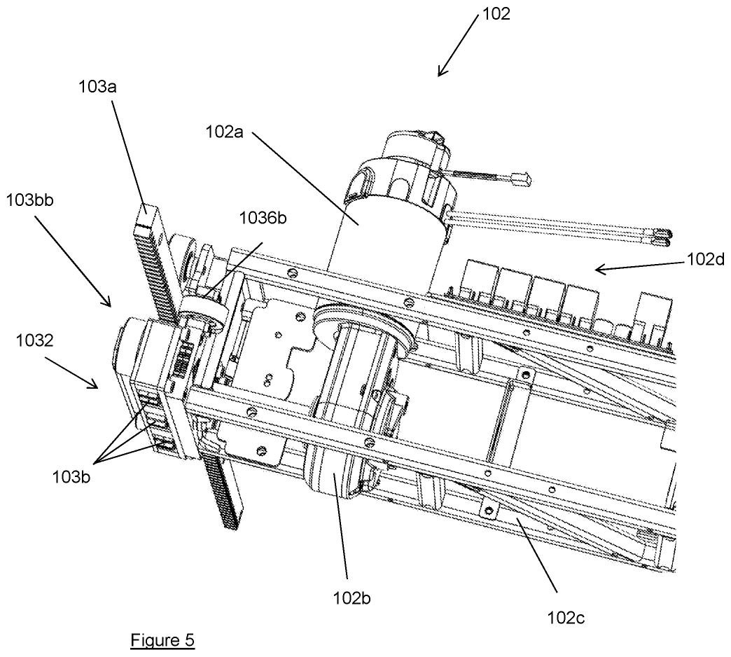

As described herein, the elevator drive mechanism 102 includes a control system 102d (see FIGS. 5 and 26). The control system 102d may be communicatively coupled (e.g. through a wired or wireless communication link) to a user control panel through which the user can instruct operation of the elevator car 101 (e.g. movement between levels).

The control system 102d may be configured to control the elevator drive motor or motors 102a and may be communicatively coupled (e.g. through a wired or wireless communication link) to one or more sensors 104 associated with the elevator car 101 to assist in the control of the operation of the elevator drive motor or motors 102a.

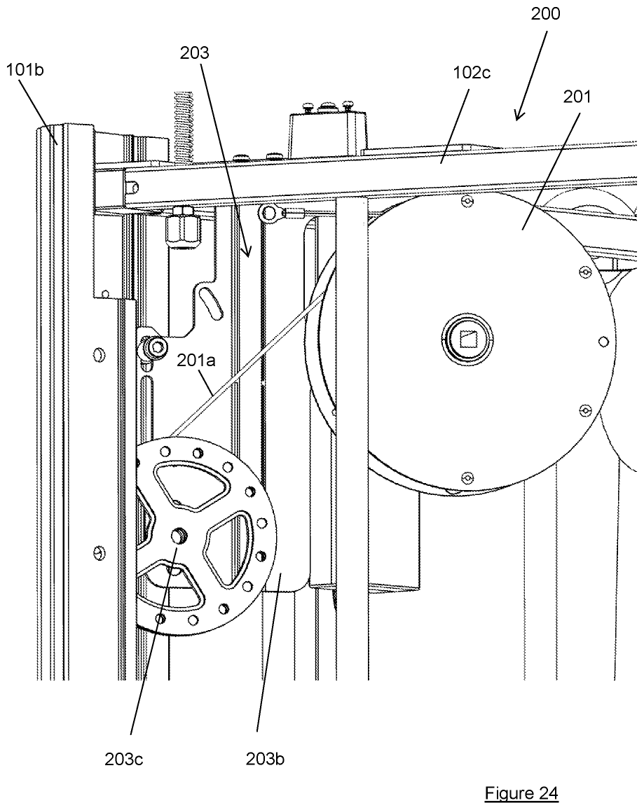

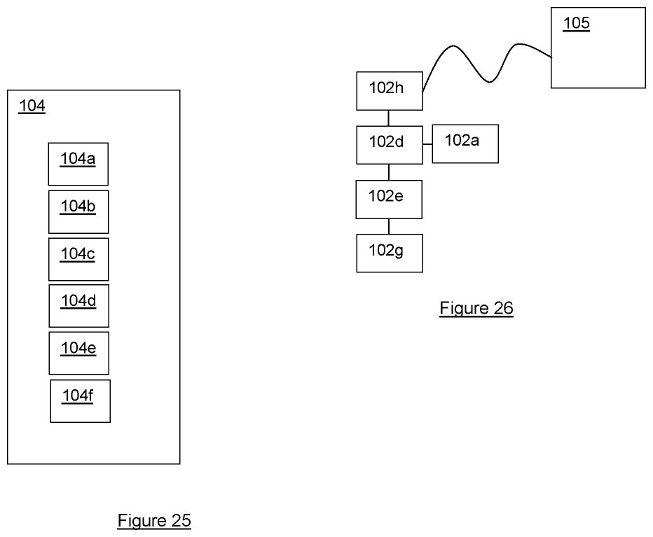

The one or more sensors 104 (see FIG. 25) may include, for example:
a level sensor 104a (configured to detect whether the elevator car 101 is level (i.e. with a floor of the transportation compartment generally horizontal),
a speed sensor 104b (configured to detect the speed of vertical movement of the elevator car 101 and/or horizontal speed of the elevator car 101),
a distance sensor 104c (configured to detect the distance travelled by the elevator car 101 which is typically a vertical distance travelled),
a weight or load sensor 104d (configured to detect the size of a load (e.g. its weight) in the transportation compartment (the load may or may not include the weight of the elevator car 101)),
an acceleration sensor 104e (configured to detect the vertical and/or horizontal acceleration of the elevator car 101),
one or more obstruction sensors 104f (such as the proximity sensors mentioned herein, which may be configured to detect the presence of an obstruction which would hinder the operation of the elevator system 1 (e.g. the movement of the elevator car 101)).

In some versions, the control system 102d may be configured to control the operation of the elevator drive motor or motors 102a depending on the load detected by the one or more sensors 104 (e.g. by the weight or load sensor 104d). For example, the elevator drive motor or motors 102a may be controlled to operate more slowly when the load is above a predetermined threshold. In some versions, there may be a plurality of such thresholds and associated speeds of operation of the elevator drive motor or motors 102a. This may help, for example, to reduce wear, vibration, and noise.

In some versions, the control system 102d may be configured to control the elevator drive motor or motors 102a at the start and/or end of movement of the elevator car 101 based on the load detected by the one or more sensors 104 (e.g. by the weight or load sensor 104d). The control system 102d may be configured to accelerate the elevator car's 101 movement up to its travelling speed at the start of the movement of the elevator car 101 and this acceleration may be higher if the detected load indicates that there is unlikely to be a person in the transportation compartment (e.g. if the load is below a predetermined threshold, which may be, for example, 500 N (e.g. representing a mass of about 50 kg)). The control system 102d may be configured to decelerate the elevator car's 101 movement down to a stop at the end of the movement of the elevator car 101 and this deceleration may be higher if the detected load indicates that there is unlikely to be a person in the transportation compartment (e.g. if the load is below a predetermined threshold, which may be, for example, 500 N (e.g. representing a mass of about 50 kg)). Such faster acceleration and/or deceleration may be provided because, in such situations, occupant comfort is not an issue (because there is no occupant) and it is likely that someone is waiting to use the elevator car 101 (so fast arrival at that person is preferable). In some versions, the control system 102d may be configured to accelerate and/or decelerate the movement of the elevator car 101 at a lower rate when the load is over a predetermined threshold. Therefore, for example, when the load is indicative of the presence of more than one person in the transportation compartment, acceleration and deceleration may be lower. This may help to improve comfort, and/or reduce vibration and noise.

In some versions, the control system 102d is configured to seek to control the elevator drive motor or motors 102a to maintain a substantially constant travel speed (i.e. the normal speed of vertical movement after the initial acceleration and before the deceleration to the destination). This may seek to prevent the elevator car 101 from running away (under gravity) when moving downwardly in particular.

In some versions, the control system 102d may be configured to stop the elevator car's 101 movement for a particular level at a location which is dependent on the load detected by the one or more sensors 104 (e.g. by the weight or load sensor 104d). For example, a higher load may mean that the transportation compartment 101a is at a different relative location to the elevator drive mechanism 102 than when there is a lower load. This may be, for example, a result of the mounting of the transportation compartment 101a to the elevator drive mechanism 102 and/or flex in the structure of the transportation compartment 101a. Therefore, a floor of the transportation compartment 101a may not properly align with the floor on a particular level depending on the load. The control system 102d may be configured to stop the elevator car 101 such that for a particular level, the elevator car 101 is higher when the load is higher and lower when the load is lower. In some versions, when a load above a predetermined threshold leaves the transportation compartment 101a, the control system 102d may be configured to lower the elevator car 101 to the lower load position for that level, for example.

As described herein, the elevator car 101 may include frame members 101b. In some versions, these frame members 101b form at least part of a cage to which different panels may be fitted in a modular and interchangeable manner. Accordingly, the same cage may allow a plurality of different panels to be fitted (including different floors to the elevator car's 101 transportation compartment 101a) and this may allow the same frame members 101b to provide not only a plurality of different aesthetic forms of the elevator car 101 but also different sizes of elevator car 101 (i.e. with different sized transportation compartment 101a sizes).

In some versions, the floor of the transportation compartment 101b may be mounted to one or more frame members 101b in a hinged or flexible manner. This may allow the floor of the transportation compartment to flex (e.g. underload) without excessive force on the frame members 101b and/or other panels of the elevator car 101. This may mean, for example, that side walls of the transportation compartment 101a (which may be formed by panels and/or frame members 101b) are less likely (i.e. are inhibited from) bowing (e.g. inwardly) as a result.

In some versions, the distance sensor 104c may include a distance sensor 104c associated with each elevator drive motor 102a and may be configured to determine the number of rotations of the output shaft of that motor 102a and the direction of rotation (e.g. each motor 102a may have an optical encoder wheel associated therewith). In some versions, the control system 102d is configured to determine the position of the elevator car 101 using the acceleration sensor 104e. In particular, the acceleration of the elevator car 101 and the duration of its movement at its travelling speed may be used to determine the position of the elevator car 101. The control system 102d may be configured to use this determination of the position of the elevator car 101 to cross-check the position determined in another manner (e.g. through use of the distance sensor 104c) or vice versa.

There may be more than one acceleration sensor 104e which may be positioned on respective different parts of the elevator car 101. In some versions, there is one acceleration sensor 104e associated with each of the elevator drive motor or motors 102a (e.g. located adjacent or towards a side of the elevator car 101 in which that elevator drive motor 102a is located). A disparity in the position of the elevator car 101 as determined by each of the acceleration sensors 104e may mean that the elevator car 101 is not level and this may be used to trigger an alarm or alert (which may be an audible or visual alert to the user and/or a signal sent to a maintenance facility via a communication system 102h of the control system 102d.

In some versions, in which the distance sensor 104c may include a distance sensor 104c associated with each elevator drive motor 102a and may be configured to determine the number of rotations of the output shaft of that motor 102a and the direction of rotation (e.g. each motor 102a may have an optical encoder wheel associated therewith), a disparity between the distances associated with two motors 102a may indicate that the elevator car 101 is not level and this may be used to trigger an alarm or alert (which may be an audible or visual alert to the user and/or a signal sent to the maintenance facility via the communication system 102h of the control system 102d.

The control system 102d may be configured to compare the indication that the elevator car 101 is not level from, for example, the distance sensors 104c and acceleration sensors 104e, to determine if one of the indications is a potentially a false indication (e.g. due to a faulty sensor). If both sets of sensors 104c/e indicate that the elevator car 101 is not level, then the indication may be confirmed as correct (e.g. trigging the alert or alarm). If only one set of sensors 104c/e indicates that the elevator car 101 is not level, then the indication may not be confirmed as correct and this may mean that the alert/alarm is not triggered and/or that the control system 102d records this as an error and/or communicates a potential error to the maintenance facility via the communication system 102h.

The control system 102d may include the communication system 102h, as already described. The communication system 102h could take a number of different forms but is configured to send and/or receive data to the maintenance facility (e.g. to a remote computer 105 of the maintenance facility). The communication system 102h may, therefore, be configured to connect to a wireless (e.g. Wi-Fi® or cellular telephone) network or a wired network (e.g. Ethernet). The communication with the remote computer 105 may be via the Internet.

The control system 102d may be configured to send data to the remote computer 105 regarding a plurality of operations of the control system 102d. The remote computer 105 may be configured to collate this data and generate one or more reports and/or alarms and/or maintenance actions based on the collated data.

The data may include, for example, for each time the elevator car 101 is used:
the level on which the elevator car 101 was initially located; and/or
the level to which the elevator car 101 travelled; and/or
the time taken to travel between the initial location and destination location; and/or
the speed of travel between the initial location and destination location; and/or
the travelling speed of the elevator car 101 (i.e. after initial acceleration and before final deceleration); and/or
the acceleration of the elevator car 101; and/or
the deceleration of the elevator car 101; and/or
the direction of travel of the elevator car 101; and/or
the opening and/or closing of a door of the transportation compartment 101a; and/or
outputs from any of the one or more sensors 104; and/or
any alarms and/or alerts generated by the controls system 102d.

This data may be used by the remote computer 105 to schedule maintenance for the elevator system 101 and/or to monitor potential issues with the operation of the elevator system 101. In some versions, the remote computer 105 may be configured, as a result, to issue one or more alerts or alarms to a user of the remote computer 105 and/or the elevator system 101 regarding issues and/or maintenance of the elevator system 101.

In some versions, the remote computer 105 may be configured to identify patterns of use of the elevator system 101 by the user and to issue an alert or alarm if there is use which falls outside of the pattern of use. This alert or alarm may be issued (e.g. as a text message, telephone message, email, or other alert) to a carer for the user of the elevator system 101, for example. The remote computer 105 may be configured, for example, to detect when a load has not left the elevator car 101 when it arrives at its destination for more than a predetermined time (meaning that someone may be trapped in the transportation compartment and/or unable to leave due to injury or illness, for example).

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. An elevator drive cassette configured for use in driving the movement of an elevator car along a rail or rack, the elevator drive cassette including:
a driven pinion and drive shaft configured to be driven by a drive motor associated with the elevator car;
a mechanical coupling;
at least one further pinion configured to be driven by the driven pinion or drive shaft via the mechanical coupling, wherein both the driven pinion and at least one further pinion are configured to engage the same rail or rack.

2. The elevator drive cassette according to claim 1, wherein the mechanical coupling includes:
a first transfer gear configured to be driven by the drive shaft;
an idler gear configured to be driven by the first transfer gear; and
a second transfer gear configured to be driven by the idler gear, the second transfer gear being configured to drive the at least one further pinion.

3. The elevator drive cassette according to claim 2, wherein the first transfer gear, the idler gear, the second transfer gear, the driven pinion, and the at least one further pinion, are provided in a stack, with the first transfer gear, the idler gear, the second transfer gear provided in one layer of the stack, and the driven pinion and the at least one further pinion provided in a second layer of the stack.

4. The elevator drive cassette according to claim 1, further including one or more rollers configured to engage a part of the rail or rack, and/or another part of an elevator system with which the elevator drive cassette is to be used.

5. The elevator drive cassette according to claim 1, wherein the at least one further pinion includes at least two further pinions.

6. The elevator drive cassette according to claim 1, wherein the cassette is configured to be secured and removed from a frame of an elevator drive mechanism as a unitary piece.

7. An elevator drive cassette configured for use in driving the movement of an elevator car along a rail or rack, the elevator drive cassette including:
a bearing block;
one or more linear bearings supported by the bearing block and configured to support the passage of the rail or rack therethrough.

8. The elevator drive cassette according to claim 7, wherein the or each linear bearing includes a collar and a plurality of inward extensions defining a tube-like channel through which the rack or rail is passable.

9. The elevator drive cassette according to claim 7, further including a pinion configured to engage the rail or rack, the pinion being configured to be driven by a drive motor.

10. [An] The elevator drive cassette according to claim 1, further including a flexible mounting mechanism configured to permit movement between the elevator drive cassette and a frame to which the elevator drive cassette is mountable.

11. The elevator drive cassette according to claim 10, wherein the flexible mounting mechanism includes one or more cushioned mounting blocks and a flexible mounting mechanism bracket, the one or more cushioned mounting blocks being configured to be sandwiched between the frame and the flexible mounting mechanism bracket with the frame above the flexible mounting mechanism bracket.

12. The elevator drive cassette according to claim 10, wherein the flexible mounting mechanism further includes a flexible mounting spring secured between a main body of the elevator drive cassette and the flexible mounting mechanism bracket.

13. The elevator drive cassette according to claim 10, wherein the flexible mounting mechanism is configured to permit rotational movement between the elevator drive cassette and the frame to which the elevator drive cassette is mountable.

14. An elevator system including:
an elevator car with a transportation compartment;
a rack or rail along which the elevator car is configured to be driven; and
an elevator drive mechanism configured to drive the elevator car along the rack or rail, wherein the elevator drive mechanism includes at least one elevator drive motor and at least one elevator drive cassette configured for use in driving the movement of the elevator car along the rail or rack, the elevator drive cassette including:
a driven pinion and drive shaft configured to be driven by the at least one drive motor;
a mechanical coupling;
at least one further pinion configured to be driven by the driven pinion or drive shaft via the mechanical coupling, wherein both the driven pinion and at least one further pinion are configured to engage the same rail or rack.

15. A brush for contacting a conductor for the transfer of electrical power, the brush including:
a brush member formed from an electrically conductive material;
a first biasing stage configured to bias the brush member in a first direction; and
a second biasing stage configured to bias the first biasing stage in the first direction.

16. An elevator fire seal system, the system including:
a cable spool mountable to an elevator car and configured to collect and release a cable; and
a fire seal member mountable to the elevator car and suspended by the cable, such that release of the cable from the cable spool permits movement the fire seal away from the elevator car and collection of the cable by the cable spool moves the fire seal towards the elevator car.

17. The elevator fire seal system according to claim 16, wherein the cable spool is a spring biased cable spool.

18. (canceled)

19. (canceled)

20. An elevator system including:
an elevator car with a transportation compartment;
a rack or rail along which the elevator car is configured to be driven;
an elevator drive mechanism configured to drive the elevator car along the rack or rail, wherein the elevator drive mechanism includes at least one elevator drive motor and at least one elevator drive cassette configured for use in driving the movement of the elevator car along the rail or rack, the elevator drive cassette including:
a driven pinion and drive shaft configured to be driven by the at least one drive motor:
a mechanical coupling;
at least one further pinion configured to be driven by the driven pinion or drive shaft via the mechanical coupling, wherein both the driven pinion and at least one further pinion are configured to engage the same rail or rack; and an elevator fire seal system, the system including:
a cable spool mountable to the elevator car and configured to collect and release a cable; and
a fire seal member mountable to the elevator car and suspended by the cable, such that release of the cable from the cable spool permits movement the fire seal away from the elevator car and collection of the cable by the cable spool moves the fire seal towards the elevator car.

21. The elevator system according to claim 20, further including a brush for contacting a conductor for the transfer of electrical power, the brush including:
a brush member formed from an electrically conductive material;
a first biasing stage configured to bias the brush member in a first direction; and
a second biasing stage configured to bias the first biasing stage in the first direction.
